(19) United States
(12) Patent Application Publication
(10) Pub. No.: US 2010/0205125 A1
(43) Pub. Date: Aug. 12, 2010

(54) IDENTIFYING INVENTION FEATURE PERMUTATIONS FOR A REASONABLE NUMBER OF PATENT APPLICATION CLAIMS

(76) Inventors: Lorne A. Whitehead, Vancouver (CA); Michele Ann Mossman, Vancouver (CA); Blake R. Wiggs, Richmond (CA)

Correspondence Address: OYEN, WIGGS, GREEN & MUTALA LLP;480 - THE STATION, 601 WEST CORDOVA STREET, VANCOUVER, BC, V6B 1G1, CA

(21) Appl. No.: 12/701,706

(22) Filed: Feb. 8, 2010

Related U.S. Application Data
(60) Provisional application No. 61/150,901, filed on Feb. 9, 2009.

(51) Int. Cl. G06F 15/18; G06N 5/02

(52) U.S. Cl. 706/12; 706/54

(57) ABSTRACT

Permutations of features of an invention are ranked in accordance with factors such as importance and specificity to identify a reasonable number of (i.e. 20 or fewer) permutations as candidates for structuring a corresponding number of claims for a patent application. The identified permutations desirably include permutations corresponding to claims of broad scope, claims of narrow scope, and claims of intermediate scope; and exclude illogical or impractical permutations of features.

### REFERENCE TO RELATED APPLICATION

This application claims the benefit of U.S. provisional patent application Ser. No. 61/150,901 filed 9 Feb. 2009.

### TECHNICAL FIELD

A method of identifying permutations of features of an invention which can be used to structure a reasonable number of (e.g. 20) patent application claims including claims of broad scope, claims of narrow scope, and a uniform range of claims of intermediate scope is disclosed.

### BACKGROUND

A typical patent application includes one or more claims defining a desired scope of protection for an invention. Broad claims are desirable because they provide greater protection than narrow claims. Narrow claims are also desirable because they may more readily patentably distinguish prior art than broad claims, so a Patent Office Examiner may be more willing to allow a narrow claim than a broad claim. Patent applications often include claims of broad, narrow, and intermediate scope.

For example, if the wheel invention were unknown, an application to patent that invention might include a broad claim such as hypothetical claim 1 shown in Table 1. Suppose the wheel inventor had also conceived and reduced to practice features such as a rubber tire for the wheel, a capability to inflate the tire, a capability to replace the tire with another tire, a tread pattern for the tire, and a tread pattern incorporating specific geometric shapes. To protect different combinations of such features, the same patent application might include dependent claims such as hypothetical claims 2-29 shown in Table 1.

TABLE 1
Hypothetical Claims For the Wheel Invention

| | |
|---|---|
| 1 | A disc having a central axle. |
| 2 | A disc as defined in claim 1, circumferentially surrounded by a tire. |
| 3 | A disc as defined in claim 2, wherein the tire is made of rubber. |
| 4 | A disc as defined in claim 2, wherein the tire is inflatable. |
| 5 | A disc as defined in claim 3, wherein the tire is inflatable. |
| 6 | A disc as defined in claim 2, wherein the tire is replaceable. |
| 7 | A disc as defined in claim 3, wherein the tire is replaceable. |
| 8 | A disc as defined in claim 4, wherein the tire is replaceable. |
| 9 | A disc as defined in claim 2, wherein the tire has treads. |
| 10 | A disc as defined in claim 3, wherein the tire has treads. |
| 11 | A disc as defined in claim 4, wherein the tire has treads. |
| 12 | A disc as defined in claim 5, wherein the tire has treads. |
| 13 | A disc as defined in claim 6, wherein the tire has treads. |
| 14 | A disc as defined in claim 7, wherein the tire has treads. |
| 15 | A disc as defined in claim 8, wherein the tire has treads. |
| 16 | A disc as defined in claim 9, wherein the treads are arranged in a |
| | geometrically repeating pattern. |
| 17 | A disc as defined in claim 10, wherein the treads are arranged in a |
| | geometrically repeating pattern. |
| 18 | A disc as defined in claim 11, wherein the treads are arranged in a |
| | geometrically repeating pattern. |
| 19 | A disc as defined in claim 12, wherein the treads are arranged in a |
| | geometrically repeating pattern. |
| 20 | A disc as defined in claim 13, wherein the treads are arranged in a |
| | geometrically repeating pattern. |
| 21 | A disc as defined in claim 14, wherein the treads are arranged in a |
| | geometrically repeating pattern. |
| 22 | A disc as defined in claim 15, wherein the treads are arranged in a |
| | geometrically repeating pattern. |
| 23 | A disc as defined in claim 16, the pattern including shapes that are |
| | sections of ellipses having eccentricity values between 2.5 and 2.7. |
| 24 | A disc as defined in claim 17, the pattern including shapes that are |
| | sections of ellipses having eccentricity values between 2.5 and 2.7. |
| 25 | A disc as defined in claim 18, the pattern including shapes that are |
| | sections of ellipses having eccentricity values between 2.5 and 2.7. |
| 26 | A disc as defined in claim 19, the pattern including shapes that are |
| | sections of ellipses having eccentricity values between 2.5 and 2.7. |
| 27 | A disc as defined in claim 20, the pattern including shapes that are |
| | sections of ellipses having eccentricity values between 2.5 and 2.7. |
| 28 | A disc as defined in claim 21, the pattern including shapes that are |
| | sections of ellipses having eccentricity values between 2.5 and 2.7. |
| 29 | A disc as defined in claim 22, the pattern including shapes that are |
| | sections of ellipses having eccentricity values between 2.5 and 2.7. |

Hypothetical claim 1 is the broadest claim in Table 1, in the sense that any disc having a central axle would infringe that claim, regardless of what other features the accused infringing structure might have. Hypothetical claim 2 is narrower than hypothetical claim 1, because in addition to having a disc and a central axle, the disc of the accused infringing structure would also have to be circumferentially surrounded by a tire in order to literally infringe hypothetical claim 2. Hypothetical claim 3 is narrower than hypothetical claim 2, because in addition to having a disc circumferentially surrounded by a tire and a central axle, the tire of the accused infringing structure would also have to be made of rubber in order to literally infringe hypothetical claim 3.

Hypothetical claims 23-28 are the narrowest claims in Table 1, in the sense that in order to literally infringe any of those claims, in addition to having a disc circumferentially surrounded by a tire and a central axle, the tire of the accused infringing structure would also require treads arranged in a geometrically repeating pattern including shapes that are sections of ellipses having eccentricity values between 2.5 and 2.7.

Although it may be rare to encounter an invention having a range of potentially patentable features comparable to the foregoing hypothetical, patent applications commonly include a range of claims of broad, intermediate and narrow scope. Patent applications also commonly include claims of different types, such as method claims, product-by-process claims, and others. A patent application which includes different claim types may also include claims of broad, intermediate and narrow scope for each different claim type (i.e. broad, intermediate and narrow method claims; broad, intermediate and narrow product-by-process claims; etc.).

Patent applications sometimes include dozens of claims of differing scope in order to protect different combinations of features of an invention, or to provide a possible basis for distinguishing prior art which may not be discovered until after the patent application is filed in the Patent Office or after the patent is granted. However it can be undesirable to include dozens of claims in a patent application for various reasons.

One reason is that some Patent Offices charge patent application filing fees which increase depending on the number of claims included in the application. For example, the Fiscal Year 2009 Fee Schedule of the United States Patent & Trademark Office (USPTO) stipulates an additional filing fee of $26 per claim for each claim in excess of 20 claims. If the applicant does not qualify as a small entity then the additional filing fee is $52 per claim for each claim in excess of 20 claims. A United States patent application including the hypothetical set of claims shown in Table 1 would require payment of an additional $234 filing fee (or $468 if the applicant did not qualify as a small entity) if filed while the Fiscal Year 2009 Fee Schedule was in effect.

As another example, the European Patent Office (EPO) charges an additional filing fee of 200 Euros per claim for each claim in excess of 15 claims. Consequently, a European patent application including the hypothetical set of claims shown in Table 1 would require payment of an additional 2,800 Euro filing fee if filed while the EPO's 1 Apr. 2009 Fee Schedule was in effect. In addition to charging 200 Euros per claim as aforesaid for each of the 16^{th} through 50^{th} claims in a European patent application, the EPO charges a further 500 Euros per claim for each claim in excess of 50 claims.

Other countries, including Argentina, Australia, Brazil, China, India, Japan, Pakistan, the Philippines, Russia, Singapore, South Korea, Taiwan and the African Intellectual Property Organization (currently consisting of Benin, Burkina Faso, Cameroon, Central African Republic, Chad, Congo, Côte d'Ivoire, Equatorial Guinea, Gabon, Guinea, Guinea-Bissau, Mali, Mauritania, Niger, Senegal and Togo) also charge fees which may increase depending on the number of claims in the application. In some cases, the amount by which the fee increases is directly related to the number of claims in the patent application. In other cases, the amount by which the fee increases may only be indirectly related to the number of claims in the application. For example, the amount by which the fee increases may depend on the number of pages in the patent application. If a patent application has a large number of claims, then the number of pages in the patent application may exceed a page limit beyond which additional fees must be paid to the Patent Office in which the application is filed.

It can also be undesirable to include dozens of claims in a patent application in view of proposals to require fulfillment of additional non-fee requirements if the patent application includes more than a specified number of claims. For example, the USPTO proposed various requirements (which were eventually withdrawn) in a notice titled “Changes to Practice for Continued Examination Filings, Patent Applications Containing Patentably Indistinct Claims, and Examination of Claims in Patent Applications” (see 72 Fed. Reg. 46,716-843, Aug. 21, 2007). One such proposed requirement would have required an applicant who filed a patent application containing 25 or more claims to provide an “examination support document” (ESD) containing information about the claims to assist USPTO Examiners in determining the patentability of the claimed invention. Some patent practitioners considered this to be a burden having potentially significant undesirable consequences. Although the USPTO's proposed requirements have been rescinded (see the USPTO's 8 Oct. 2009 Press Release 09-21 “USPTO Rescinds Controversial Patent Regulations Package Proposed by Previous Administration”) it is conceivable that comparable requirements could arise in future, either with respect to the United States or elsewhere.

It can also be undesirable to include dozens of claims in a patent application since the Patent Office is burdened with the task of reviewing each claim to assess its merits, which consumes significant resources, including time spent by Patent Office Examiners in assessing each claim to determine whether it defines patentable subject matter.

The challenge is to include in a patent application a reasonable number of (i.e. 20 or fewer) claims of varying scope so as to:
protect different combinations of features of the invention;
potentially accommodate later-discovered prior art;
minimize filing fees; and
avoid the need to comply with non-fee measures applicable to patent applications which include more than a predefined number of claims.
   This disclosure addresses that challenge.

The foregoing examples of the related art and limitations related thereto are intended to be illustrative and not exclusive. Other limitations of the related art will become apparent to those of skill in the art upon a reading of the specification and a study of the drawings.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 depicts selected rows of a worksheet representing permutations of 14 features of a hypothetical invention.

FIG. 2 depicts selected rows of a worksheet containing only those FIG. 1 permutations which correspond to logical, practical candidates for structuring patent application claims.

FIG. 3 depicts selected rows of a worksheet showing total specificity S_{T} and total importance I_{T} characteristics of the FIG. 2 candidate permutations.

FIG. 4 depicts selected rows of a worksheet produced by rearranging the FIG. 3 candidate permutations in ascending total specificity S_{T} order and allocating an overall specificity rank value S_{R} to each candidate permutation.

FIG. 5 reproduces the FIG. 4 worksheet and shows allocation of a specificity group S_{G} to each candidate permutation.

FIG. 6 depicts rearrangement of the FIG. 5 candidate permutations in numerical order and shows allocation of a select attribute to each candidate permutation, based on the permutation's total importance I_{T}.

FIG. 7 depicts rearrangement of the FIG. 6 candidate permutations within each specificity group S_{G}, in descending total importance I_{T}.

FIG. 8 depicts a worksheet produced by selecting from the FIG. 7 worksheet those candidate permutations having a predefined select attribute.

FIG. 9 depicts a worksheet containing the invention feature permutations of the FIG. 8 candidate permutations.

FIG. 10 is a flowchart depiction of a method of constructing a reasonable number of patent application claims.

FIG. 11 is a flowchart depiction of a method of randomly selecting a reasonable number of candidate permutations identified by the FIG. 10 method.

FIG. 12 is a flowchart depiction of a method of selecting a reasonable number of candidate permutations in accordance with importance and specificity characteristics of the identified candidate permutations.

FIGS. 13A, 13B, 13C and 13D respectively graphically depict claim importance vs. specificity distributions for sets of 43, 20, 15 and 10 claims directed to an invention having 20 invention features.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

To facilitate the drafting of a set of claims for inclusion in a patent application, it is useful to briefly summarize features characterizing the invention which is to be patented. For example, the aforementioned wheel invention might be hypothetically characterized by 14 features as shown in Table 2. It is assumed that these features have previously been evaluated in relation to known prior art and that these features are believed to be potentially patentable, either individually or in combination with another one or more of the Table 2 features.

TABLE 2
Hypothetical Features of the Wheel Invention

| | | | Importance |
|---|---|---|---|
| No. | Feature | Specificity (S) | (I) |
| 1 | wheel | 1 | 5 |
| 2 | wheel has replaceable tire | 2 | 5 |
| 3 | tire is made of rubber | 2 | 5 |
| 4 | rubber is latex rubber | 2 | 3 |
| 5 | rubber contains carbon black | 3 | 3 |
| 6 | rubber is vulcanized | 3 | 3 |
| 7 | rubber is neoprene rubber | 3 | 1 |
| 8 | tire is pneumatic | 3 | 5 |
| 9 | tire has inflation tube | 3 | 3 |
| 10 | inflation tube has valve | 3 | 3 |
| 11 | inflation tube has replaceable cap | 3 | 4 |
| 12 | tire has tread | 3 | 5 |
| 13 | tread has herringbone shape | 5 | 4 |
| 14 | tread has elliptical sections shape | 5 | 2 |

For example, a patent application might present feature 1 via an independent claim (i.e. claim 1) such as “A disc having a central axle.” The same patent application might present features 1 and 2 via a dependent claim such as “A disc as defined in claim 1, circumferentially surrounded by a replaceable tire.” The same patent application might present features 1, 2 and 3 via yet another dependent claim such as “A disc as defined in claim 1, circumferentially surrounded by a replaceable rubber tire.” And so on.

Since there are 14 features, there are 2¹⁴=16,384 possible permutations of those features (i.e. each feature may be either present or absent in each permutation). This implies 16,384 possible claims, but many of the initial permutations are illogical and should be excluded because certain features cannot be claimed unless other features are also claimed. For example, feature 14 “tread has elliptical sections shape” cannot be presented in a claim which does not also present or depend from a claim which presents feature 12 “tire has tread” since there cannot be a tread shape without a tread to apply the shape to. Similarly, feature 12 cannot be presented in a claim which does not also present one or more of features 2, 3 or 8 since there cannot be a tread without a tire. Some other initial permutations are impractical or illogical and should be excluded because certain features should not be claimed if a conflicting feature is claimed. For example, feature 4 should not be presented in a claim which presents feature 7, and vice versa, since a practical tire would not be made of both latex rubber and neoprene rubber. As explained below, exclusion of impractical or illogical ones of the initial permutations reduces the number of permutations of Table 2 features from 16,384 to 246 candidate permutations. This implies 246 possible claims, which is still too many claims. Only about 20 claims are desired.

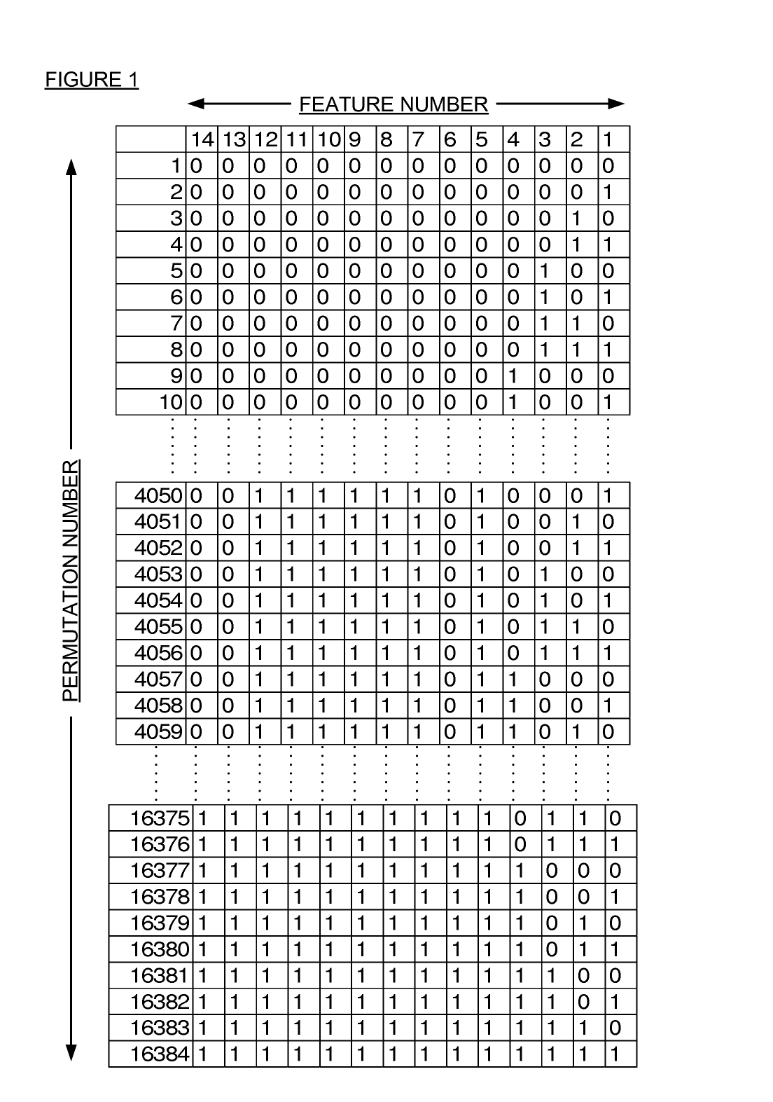

As an example, computer software can be used to generate a worksheet, table, list or other computer-manipulable representation of all possible permutations of a selected number of features. FIG. 1 depicts selected rows of a computer-generatable worksheet having columns which correspond to potentially patentable invention features, and having rows which correspond to initial permutations of those features. Specifically, the FIG. 1 worksheet has 14 “Feature Number” columns, each corresponding to one of the 14 hypothetical features of the wheel invention shown in Table 2. The FIG. 1 worksheet has 2¹⁴=16,384 rows, each corresponding to one of the aforementioned initial permutation of those features.

The rightmost column in FIG. 1 is labelled “1” (at the top of the column) and corresponds to Table 2's “wheel” feature number 1. The FIG. 1 column to the immediate left of the rightmost column is labelled “2” and corresponds to Table 2's “wheel has replaceable tire” feature number 2. The other FIG. 1 columns are labelled 3, 4, . . . , 14 and correspond to Table 2's features 3, 4, . . . , 14 respectively.

The uppermost row in FIG. 1 is labelled “1” (on the left side of the row) and corresponds to a first initial permutation of Table 2's 14 hypothetical features. The FIG. 1 row immediately beneath the uppermost row is labelled “2” and corresponds a second initial permutation of Table 2's 14 hypothetical features. The other FIG. 1 rows are labelled 3, 4, . . . , 16384 and respectively correspond to the other initial permutations of Table 2's 14 hypothetical features.

Each initial permutation (i.e. each FIG. 1 row) corresponds to a possible claim for a patent application. A binary digit (i.e. one or zero) is used to indicate the presence or absence of a feature in each permutation. In FIG. 1, the binary digit one is used to indicate that a feature is present, and the binary digit zero is used to indicate that a feature is absent. For example, all 14 columns in FIG. 1's row 1 contain the binary digit zero. The row 1 permutation “00000000000000” corresponds to a “null” claim containing no features whatever, which is clearly illogical and is therefore excluded as explained below.

The leftmost 13 columns in FIG. 1's row 2 contain the binary digit zero and the rightmost column 1 of row 2 contains the binary digit one. The row 2 permutation “00000000000001” corresponds to a claim containing only Table 2's “wheel” feature number 1, which is a logical broad claim and is therefore included as explained below.

Every column in FIG. 1's row 3 contains the binary digit zero except column 2 which contains the binary digit one. The row 3 permutation “00000000000010” thus corresponds to a claim containing only Table 2's “wheel has replaceable tire” feature number 2. The row 3 permutation is illogical and is therefore excluded as explained below, since feature 2 cannot be presented in a claim which does not also present feature 1 “wheel” because there cannot be a replaceable tire in the context of the Table 2 hypothetical invention without a wheel to support the tire.

The FIG. 1 row 4056 permutation “00111111010111” contains the binary digit zero in each of columns 4, 6, 13 and 14, and thus corresponds to a claim which does not contain any of Table 2's features 4, 6, 13 or 14. Each of columns 1, 2, 3, 5, 7, 8, 9, 10, 11 and 12 of the row 4056 permutation contains the binary digit one. The row 4056 permutation thus corresponds to a claim containing all of Table 2's features 1, 2, 3, 5, 7, 8, 9, 10, 11 and 12. If written in independent form, such a claim might be:
A wheel, comprising a disc having a central axle, the disc circumferentially surrounded by a replaceable pneumatically-inflatable tire containing an inflation tube, the tire formed of carbon black-impregnated neoprene rubber, the tube having a pressurized air inlet valve and a replaceable cap, wherein a tread is formed in and circumferentially surrounds the tire.
   This is a logical claim and is therefore included as explained below.

All 14 columns in FIG. 1's row 16384 contain the binary digit one, yielding the permutation “11111111111111” which corresponds to a claim containing all of the 14 features listed in Table 2. The row 16384 permutation is both illogical and impractical, and is therefore excluded as explained below. For example, feature 4 should not be presented in a claim which presents feature 7, and vice versa, since a practical tire would not be made of both latex rubber and neoprene rubber.

Skilled persons will understand that computer software can be configured to generate a worksheet, table, list or other computer-manipulable representation of initial permutations like that of FIG. 1.

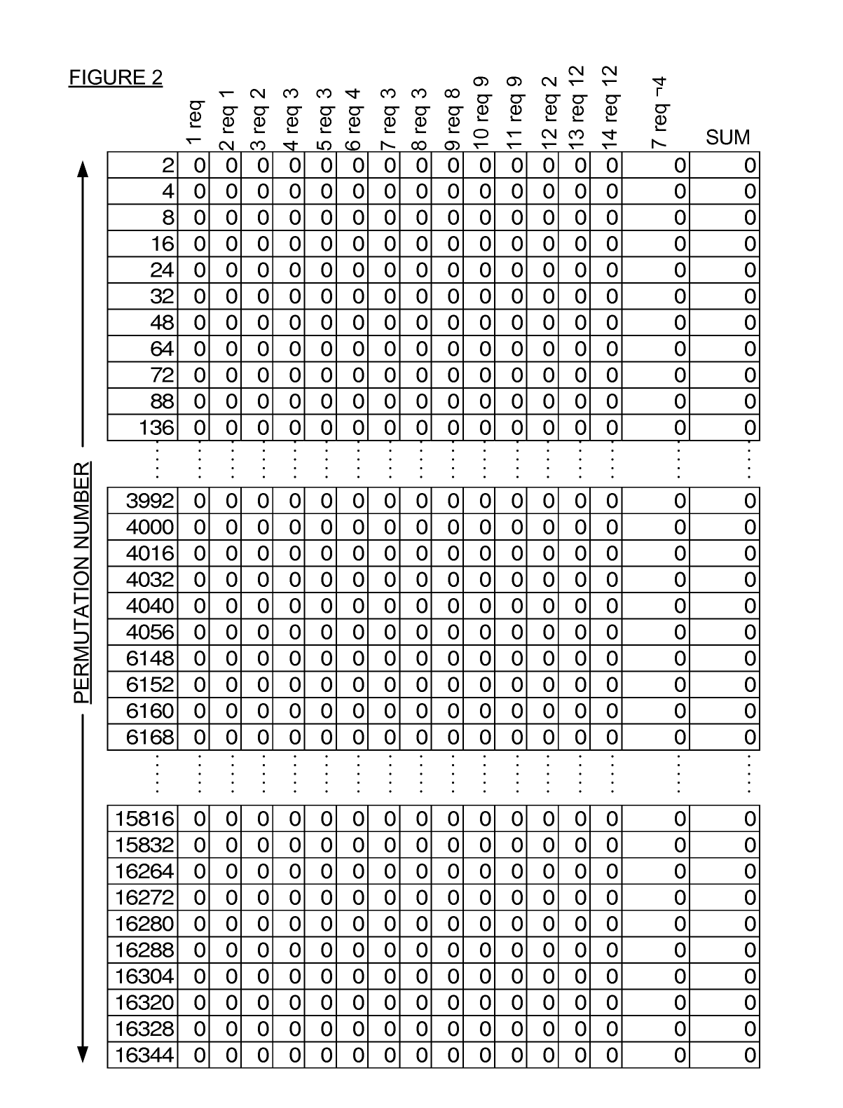

Computer software can also be used to exclude illogical or impractical permutations of features, and to thereby identify permutations which are logical, practical candidates for structuring patent application claims. For example, FIG. 2 depicts selected rows of a computer-generatable worksheet having rows which correspond to logical, practical permutations of the features listed in Table 2. Each row of the FIG. 2 worksheet has 15 “constraint result” columns containing values obtained by applying predefined constraints for including or excluding certain permutations of features. Each row of the FIG. 2 worksheet also has a “SUM” column containing a value representative of the cumulative result of applying all of the constraints to the permutation corresponding to that row.

For example, the FIG. 2 constraint result column labelled “1 req” corresponds to the constraint that Table 2's “wheel” feature number 1 is always required (“req” is an abbreviation for “required”) and must be included in every claim directed to the hypothetical wheel invention for logical consistency of the claims. The FIG. 2 constraint result column labelled “2 req 1” corresponds to the constraint that any claim which includes Table 2's “wheel has replaceable tire” feature number 2 must also include Table 2's “wheel” feature number 1, since it is illogical to refer to a replaceable tire for a hitherto unknown (i.e. inventive) wheel in a claim which does not include a wheel. Patent practitioners refer to this as a lack of antecedent basis. Similarly, the FIG. 2 constraint result column labelled “3 req 2” corresponds to the constraint that any claim which includes Table 2's “tire is made of rubber” feature number 3 must also include Table 2's “wheel has replaceable tire” feature number 2, since it is illogical to refer to rubber as a tire formation material in a claim which does not include a tire.

FIG. 2 also has a constraint result column labelled “7 req [symbol] 4”. The “ [symbol] ” symbol means “not”. The “7 req [symbol] 4” constraint result column corresponds to the constraint that any claim which includes Table 2's “rubber is neoprene rubber” feature 7 must exclude Table 2's “rubber is latex rubber” feature 4. This is because, as previously mentioned, feature 4 should not be presented in a claim which presents feature 7, and vice versa, since a practical tire would not be made of both latex rubber and neoprene rubber.

In FIG. 2, the binary digit zero indicates that a constraint is satisfied, and the binary digit one indicates that a constraint is not satisfied. As explained below, the binary digit one does not appear in FIG. 2 because all FIG. 2 rows containing the binary digit one have been excluded in order to identify permutations which are logical, practical candidates for structuring patent application claims.

The aforementioned “1 req” constraint can be implemented via a constraint formula such as 1−x where x is the binary digit value of feature 1 in the FIG. 1 row corresponding to the permutation to which the constraint formula is applied. For example, in the FIG. 1 row 1 initial permutation “00000000000000” the binary digit value of feature 1 (i.e. x) is zero. The result obtained by applying the formula 1−x to the FIG. 1 row 1 permutation is 1, corresponding to the fact that the FIG. 1 row 1 permutation does not satisfy the “1 req” constraint because that initial permutation does not include feature 1, which must appear in every claim for logical consistency. As explained below, this facilitates exclusion of the FIG. 1 row 1 initial permutation as a logical, practical candidate for structuring a potential patent application claim.

In the FIG. 1 row 2 permutation “00000000000001” the binary digit value of feature 1 (i.e. x) is one. The result obtained by applying the formula 1−x to the FIG. 1 row 2 permutation is 0, corresponding to the fact that the FIG. 1 row 2 permutation satisfies the “1 req” constraint because that permutation includes feature 1. This facilitates inclusion of the FIG. 1 row 2 permutation as a candidate for structuring a potential patent application claim, if that permutation also satisfies all other applicable constraints.

The aforementioned “2 req 1” constraint can be implemented via a constraint formula such as z·(1−y) where y and z are respectively the binary digit values of features 1 and 2 in the FIG. 1 row corresponding to the permutation to which the constraint formula is applied. For example, in the FIG. 1 row 3 permutation “00000000000010” the binary digit value of feature 1 (i.e. y) is zero and the binary digit value of feature 2 (i.e. z) is one. The result obtained by applying the “2 req 1” constraint formula z·(1−y) to the FIG. 1 row 3 permutation is z·(1−y)=1·(1−0)=1, corresponding to the fact that the FIG. 1 row 3 permutation does not satisfy the “2 req 1” constraint because that permutation includes feature 2 but does not also include feature 1 which is illogical as previously explained. This facilitates exclusion of the FIG. 1 row 3 permutation as a logical, practical candidate for structuring a potential patent application claim.

In the FIG. 1 row 4 permutation “00000000000011” the binary digit value of feature 1 (i.e. y) is one and the binary digit value of feature 2 (i.e. z) is also one. The result obtained by applying the “2 req 1” constraint formula z·(1−y) to the FIG. 1 row 4 permutation is z·(1−y)=1·(1−1)=0, corresponding to the fact that the FIG. 1 row 4 permutation satisfies the “2 req 1” constraint because that permutation includes feature 2 and also includes feature 1. This facilitates inclusion of the FIG. 1 row 4 permutation as a candidate for structuring a potential patent application claim, if that permutation also satisfies all other applicable constraints.

The FIG. 2 “3 req 2”, “4 req 3”, “5 req 3”, “6 req 4”, “7 req 3”, “8 req 3”, “9 req 8”, “10 req 9”, “11 req 9”, “12 req 2”, “13 req 12” and “14 req 12” constraints can be implemented in similar fashion via the z·(1−y) constraint formula by substituting for y and z the binary digit values of the corresponding features in the FIG. 1 row corresponding to the permutation to which the constraint is to be applied. For example, the “3 req 2”, constraint is implemented by substituting the binary digit value of feature 2 for y and substituting the binary digit value of feature 3 for z, the “4 req 3” constraint is implemented by substituting the binary digit value of feature 3 for y and substituting the binary digit value of feature 4 for z, etc.

The aforementioned “7 req [symbol] 4” constraint can be implemented via a constraint formula such as z·y where y and z are respectively the binary digit values of features 4 and 7 in the FIG. 1 row corresponding to the permutation to which the constraint formula is applied. For example, in the FIG. 1 row 4057 permutation “00111111011000” the binary digit value of feature 4 (i.e. y) is one and the binary digit value of feature 7 (i.e. z) is also one. The result obtained by applying the constraint formula z·y to the FIG. 1 row 4057 permutation is z·y=1·1=1, corresponding to the fact that the FIG. 1 row 4057 permutation does not satisfy the “7 req [symbol] 4” constraint because that permutation includes both of features 4 and 7 which is impractical as previously explained. This facilitates exclusion of the FIG. 1 row 4057 permutation as a logical, practical candidate for structuring a potential patent application claim.

In the FIG. 1 row 4050 permutation “00111111010001” the binary digit value of feature 4 (i.e. y) is zero and the binary digit value of feature 7 (i.e. z) is one. The result obtained by applying the constraint formula z·y to the FIG. 1 row 4050 permutation is z·y=1·0=0, corresponding to the fact that the FIG. 1 row 4050 permutation satisfies the “7 req [symbol] 4” constraint because that permutation includes feature 7 but does not include feature 4. This facilitates inclusion of the FIG. 1 row 4050 permutation as a candidate for structuring a potential patent application claim, if that row also satisfies all other applicable constraints.

In FIG. 2, the rightmost “SUM” column contains, for each row, the result obtained by summing the binary digit values in all of the row's constraint result columns. As previously mentioned, in the FIG. 2 constraint result columns, the binary digit zero indicates that a constraint is satisfied, and the binary digit one indicates that a constraint is not satisfied. If the binary digit one appears in one or more constraint result columns of any row, then the permutation corresponding to that row is not a logical, practical candidate for structuring a patent application claim and should accordingly be excluded. Such rows are readily identified by summation as aforesaid—any initial permutation corresponding to a FIG. 2 worksheet row for which the “SUM” column contains a non-zero value is not a logical, practical candidate for structuring a patent application claim. Conversely, any initial permutation corresponding to a FIG. 2 worksheet row for which the “SUM” column contains the value zero is a candidate for structuring a potential patent application claim.

Computer software can be developed or configured to apply constraint formulae as aforesaid to generate constraint result values for each initial permutation of features, sum the constraint result values for each initial permutation, and suppress initial permutations having non-zero summation values to yield a worksheet like that of FIG. 2.

FIG. 2 depicts only rows for which the “SUM” column contains the value zero. Application of the 15 constraints corresponding to the 15 FIG. 2 constraint result columns, to all of the 16,384 initial permutations of Table 2's 14 hypothetical features, yields 246 candidate permutations which satisfy all 15 constraints. This implies 246 possible claims, which is too many claims—only about 20 claims are desired.

A simple, brute force, approach at this stage would be to attempt to identify all possible groups of 20 of the 246 candidate permutations which satisfy all 15 constraints. The groups could then be examined to identify a “best” group which includes permutations corresponding to claims of broad scope, claims of narrow scope, and claims of intermediate scope. However, the number of such groups is 246!/(20!·226!)≈1.22437699×10²⁹ so it is impractical to determine all of the possible groups. It would also be impractical to attempt to identify a “best” group from amongst such a large number of groups.

Another approach at this stage is to randomly select 20 permutations from the 246 candidate permutations which satisfy all 15 constraints. Since every one of the 246 of the permutations which satisfy all 15 constraints is a candidate for structuring a potential patent application claim, any randomly selected number of those 246 permutations will be suitable candidates for structuring potential patent application claims. However, random selection may not yield permutations which are suitable candidates for structuring a series of claims including some claims having broad scope, some claims having narrow scope, and some claims having intermediate scope, as is desirable. This problem could be addressed by determining the “quality” of the randomly selected permutations in accordance with some predefined quality factor or factors, comparing the so-determined quality with a similarly determined quality of another group of randomly selected permutations, and retaining only the randomly selected permutations having the better quality group. This procedure could be iteratively repeated for other groups of randomly selected permutations until a group having a quality satisfying a predefined threshold is identified. Alternatively, the iterative procedure could be repeated until the quality obtained after a predefined number of iterations fails to improve by more than a predefined amount.

Another approach is to numerically rank the features of the invention and use the rank values to bias the selection of a reasonable number of (e.g. about 20) permutations from the set of permutations which satisfy all of the applicable constraints. Two or more rank types can be used, as shown in Table 2, which depicts the allocation to each feature of a numerically expressed specificity rank S, and a numerically expressed importance rank I. S may for example have an integer value of 1, 2, 3, 4 or 5; with S=1 corresponding to a very general (i.e. broad) feature, S=5 corresponding to a very specific (i.e. narrow) feature, and S=2, 3 or 4 corresponding to features of respectively intermediate specificity. I may also have an integer value of 1, 2, 3, 4 or 5; with I=1 corresponding to a feature of very low importance, I=5 corresponding to a feature of very high importance, and I=2, 3 or 4 corresponding to features of respectively intermediate importance. “Importance” may have any one of a variety of meanings, such as commercial importance, capability of distinguishing a prior art reference, etc.

In general, each integer unit of increase in an invention feature's specificity rank S may correspond to a factor of ten increase in specificity. For example, a specificity rank of S=3 could be assigned to an invention feature which is considered to be about ten times narrower than an invention feature having a specificity rank of S=2. Similarly, each integer unit of increase in an invention feature's importance rank I may correspond to a factor of ten increase in importance. For example, an importance rank of I=4 could be assigned to an invention feature which is considered to be about ten times more important than an invention feature having an importance rank of I=3. An invention feature's importance rank, I, may represent the extent to which that feature corresponds to something of business value. An invention feature which is considered to have significant business value may be assigned a higher importance rank, I, than an invention feature which is considered to have only slight business value.

Table 2 shows predefined specificity and importance rank values S, I for each one of the 14 hypothetical features of the wheel invention shown in Table 2. For example, the specificity rank value S=1 is allocated to Table 2's “wheel” feature number 1 to reflect the very general (i.e. broad) nature of that feature relative to the other features. By contrast, the specificity rank value S=5 is allocated to Table 2's “tread has herringbone shape” feature number 13 and to Table 2's “tread has elliptical sections shape” feature number 14 to reflect the very specific (i.e. narrow) nature of those features relative to the other features. Intermediate specificity rank values S=2, S=3 or S=4 are allocated to the other Table 2 features to reflect their relative specificity.

The importance rank value I=5 is allocated to Table 2's “wheel” feature number 1 to reflect the very high importance of that feature relative to the other features. By contrast, the importance rank value I=1 is allocated to Table 2's “rubber is neoprene rubber” feature number 7 to reflect the very low importance of that feature (i.e. neoprene rubber is expensive and is impractical for use in tires). Intermediate importance rank values I=2, I=3 or I=4 are allocated to the other Table 2 features to reflect their relative importance.

Specificity ranks are additive. Thus, if a permutation contains two invention features, each having a specificity rank S=2, then the total specificity S_{T} for the permutation is 2+2=4. This total specificity S_{T} reflects the fact that each invention feature restricts claim scope, such that a claim containing two invention features is narrower than a claim containing one or the other, but not both of those two features.

Importance ranks are also additive. Thus, if a permutation contains three invention features, having importance ranks of I=2, I=3 and I=3 respectively, then the total importance I_{T} for the permutation is 2+3+3=8. As explained below, this total importance I_{T} assists in the inclusion of invention features of equal importance in approximately equal amounts, and assists in the inclusion of invention features of greater importance more often than invention features of lesser importance.

The specificity and importance rank values of the features included in each permutation are accordingly summed to derive a total specificity S_{T} and a total importance I_{T} for each one of the 246 permutations which satisfy all 15 of the aforementioned constraints. For example, the FIG. 1, row 2 permutation “00000000000001” satisfies the 15 constraints and corresponds to a claim containing only Table 2's “wheel” feature number 1 which has a specificity rank value S=1 and an importance rank value I=5. Since this permutation has no other features it has a total specificity S_{T}=1 and a total importance I_{T}=5.

As another example, the FIG. 1, row 8 permutation “00000000000111” satisfies the 15 constraints and corresponds to a claim containing Table 2's feature number 1 which has a specificity rank value S=1 and an importance rank value I=5; and containing feature number 2 which has a specificity rank value S=2 and an importance rank value I=5; and containing feature number 3 which has a specificity rank value S=2 and an importance rank value I=5. The permutation “00000000000111” thus has a total specificity S_{T}=1+2+2=5 and a total importance I_{T}=5+5+5=15.

As a further example, the FIG. 1 row 4056 permutation “00111111010111” satisfies the 15 constraints and corresponds to a claim containing feature numbers 1, 2, 3, 5, 7, 8, 9, 10, 11 and 12. Having regard to the those features' specificity and importance rank values S, I shown in Table 2, the permutation “00111111010111” thus has a total specificity S_{T}=1+2+2+3+3+3+3+3+3+3=26 and a total importance I_{T}=5+5+5+3+1+5+3+3+4+5=39.

Computer software can be used to determine the total specificity S_{T} and total importance I_{T} of each one of the 246 permutations which satisfy all 15 of the aforementioned constraints. For example, a permutation's total specificity S_{T} can be calculated by multiplying the binary digit value (i.e. 0 or 1) of each feature in that permutation by the feature's specificity rank value S and summing the results. Similarly, a permutation's total importance I_{T} can be calculated by multiplying the binary digit value (i.e. 0 or 1) of each feature in that permutation by the feature's importance rank value I and summing the results.

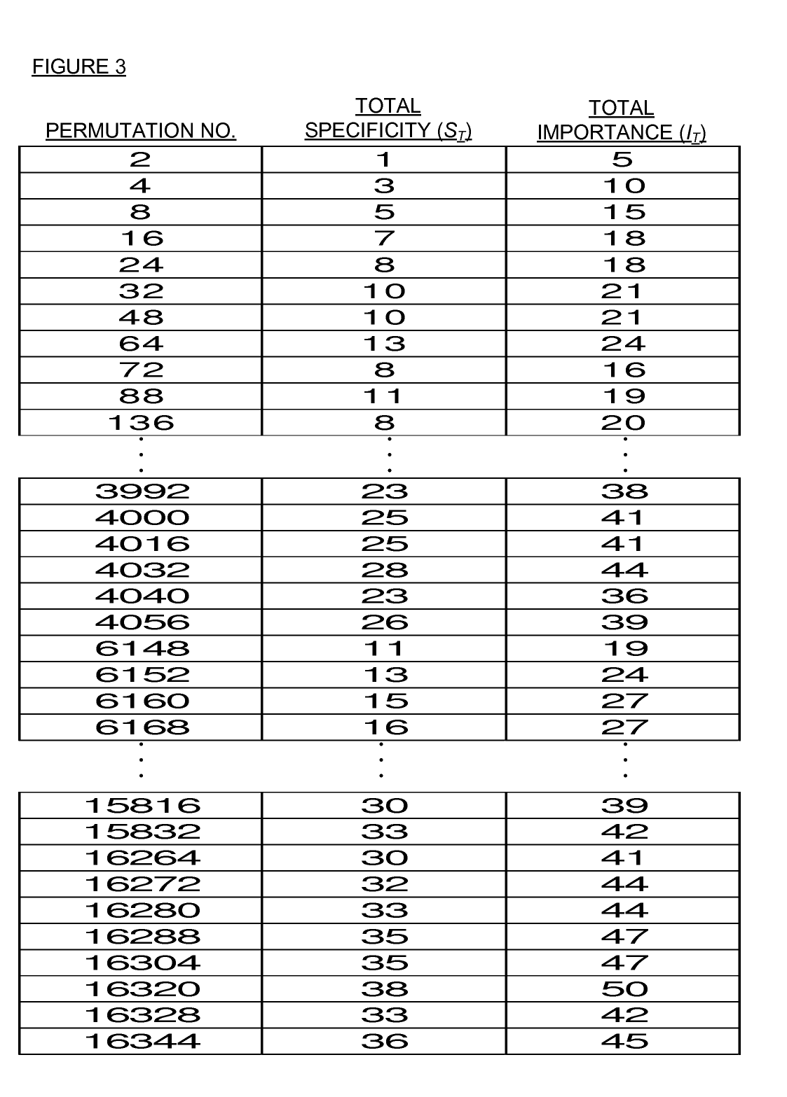

For example, the FIG. 1, row 8 permutation “00000000000111” satisfies the 15 constraints and corresponds to a claim containing features 1, 2 and 3. Features 1, 2 and 3 each have binary digit values of 1, and the remaining features 4, 5, 6, 7, 8, 9, 10, 11, 12, 13 and 14 each have binary digit values of 0. Features 1, 2 and 3 have specificity rank values of S=1, S=2 and S=2 respectively. The aforementioned multiplication and summation operations pertaining to the specificity rank values of features 1, 2 and 3 are (1·1)+(1·2)+(1·2)=5=S_{T}. Features 1, 2 and 3 each have the same importance rank value I=5. The aforementioned multiplication and summation operations pertaining to the importance rank values of features 1, 2 and 3 are (1·5)+(1·5)+(1·5)=15=I_{T}. FIG. 3 shows the total specificity S_{T} and total importance I_{T} for each one of the permutations shown in FIG. 2.

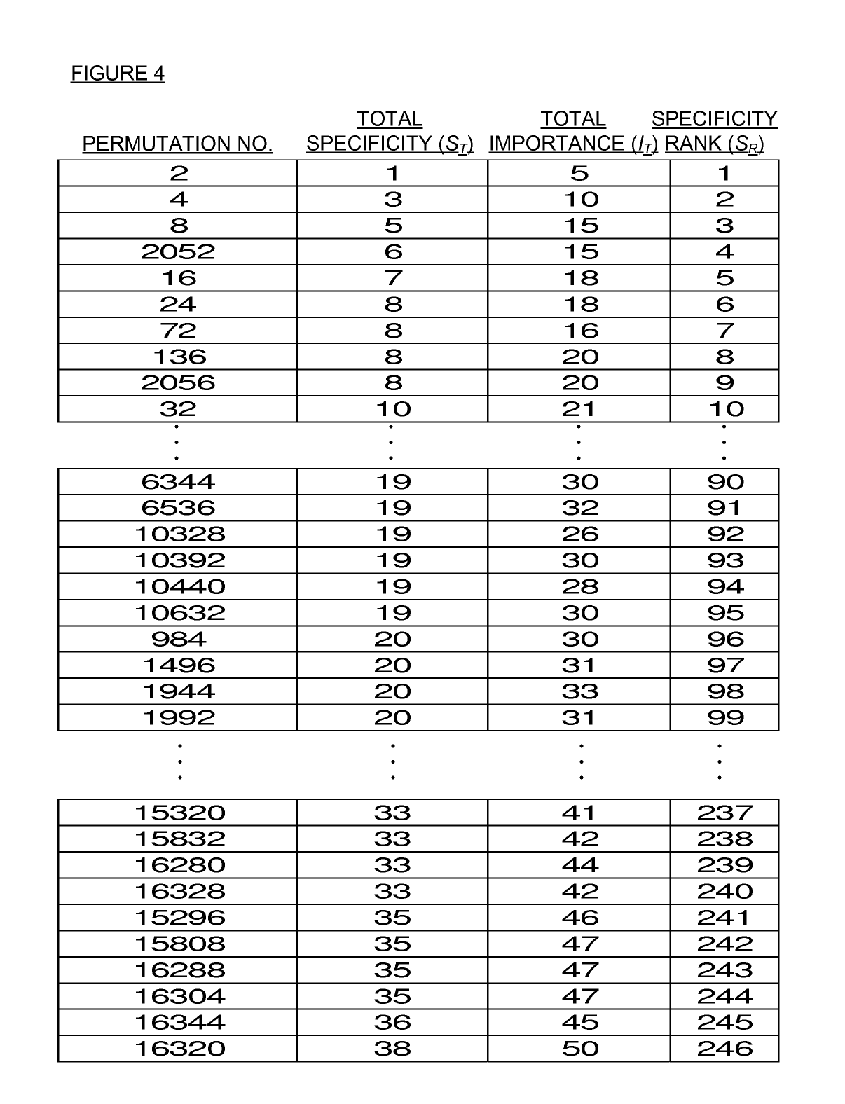

The permutations shown in FIG. 3 are then sorted in order of increasing total specificity S_{T} and permutations having the same total specificity S_{T} are further sorted in ascending permutation number order. A sequential integer overall specificity rank value S_{R} is then allocated to each permutation, as shown in FIG. 4. Since 246 permutations satisfy all 15 of the aforementioned constraints, the overall specificity rank values range from S_{R}=1 to S_{R}=246, as shown in FIG. 4.

The permutations shown in FIG. 4 are then separated into specificity groups. The total number of specificity groups equals the desired number of claims, L. For example, if L=20 claims are desired, then the FIG. 4 permutations are separated into 20 specificity groups. The FIG. 4 permutations can be separated in various ways. It is desirable that the groups range uniformly from broad to narrow scope. For example, the first group may contain permutations corresponding to claims of broad scope, the twentieth group may contain permutations corresponding to claims of narrow scope, and the second through nineteenth groups may contain permutations corresponding to claims of uniformly ranging intermediate scope.

One separation technique is to select permutations having overall specificity rank values S_{R} which differ by an equal or approximately equal amount. For example one could select the 20 FIG. 4 permutations having overall specificity rank values S_{R} which differ by 12, namely those having the S_{R} values 1, 13, 25, 37, 49, 61, 73, 85, 97, 109, 121, 133, 145, 157, 169, 181, 193, 205, 217 and 229. However, such selection tends to underweight permutations having low total specificity S_{T} relative to permutations having higher total specificity S_{T}, and thus yields a somewhat nonuniform distribution of permutations by under-emphasizing permutations containing fewer invention features. Such permutations correspond to claims of broad scope. It can be undesirable to under-emphasize claims of broad scope. It is usually desirable to have a reasonably even distribution of total specificity S_{T} values, ranging from very broad to very specific.

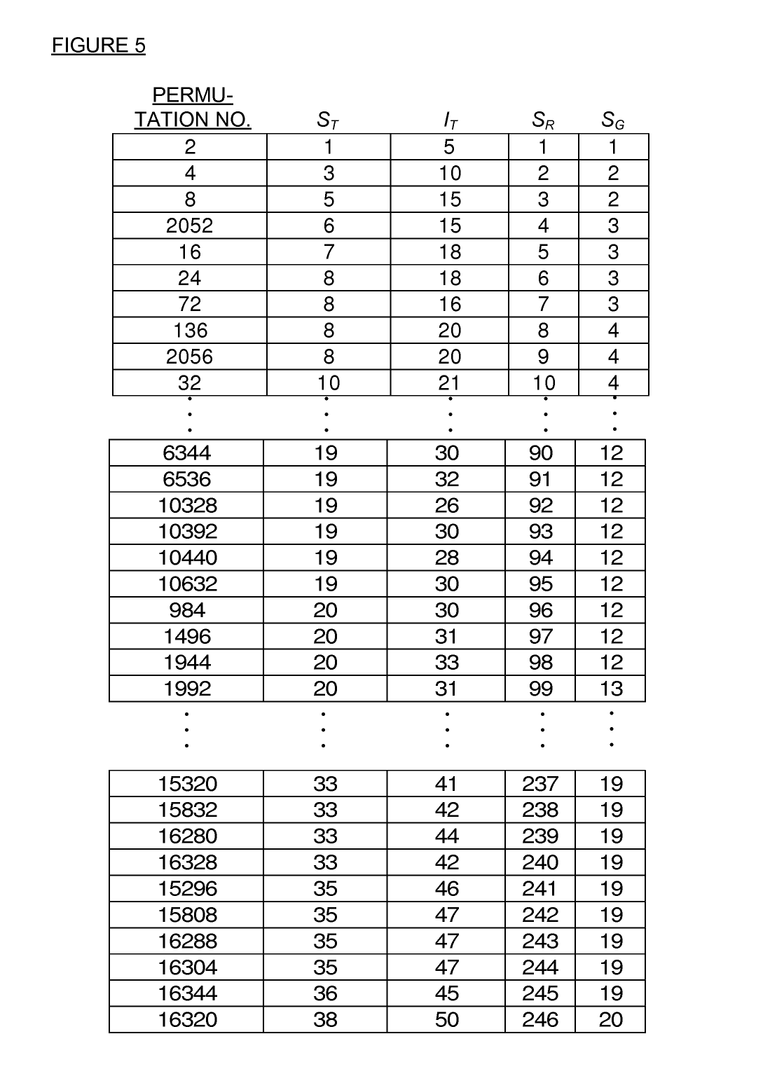

An alternative separation technique is to select permutations based upon the square roots of their overall specificity rank S_{R} values. This increases the weighting of permutations having low total specificity S_{T} relative to permutations having higher total specificity S_{T}, yielding a more uniform distribution of the permutations throughout the entire range of total specificity S_{T} values. For example, each permutation can be allocated to a specificity group S_{G} in accordance with the equation:

$${S}_{G} = INT ( \sqrt{{S}_{R} - 1} \times \frac{L - 1}{\sqrt{{P}_{T} - 1}} ) + 1 \qquad ( 1 )$$

where S_{R} is the permutation's overall specificity rank value, L is the desired number of claims (e.g. L=20) and P_{T} is the number of candidate permutations which satisfy the applicable constraints (e.g. P_{T}=246). Equation (1) yields an integer result having a minimum value of 1 and a maximum value equal to L. FIG. 5 shows specificity group S_{G} values allocated to the FIG. 4 permutations in accordance with equation (1).

After the permutations are allocated to specificity groups as shown in FIG. 5, the permutation having the highest total importance I_{T} within each specificity group is selected as the best candidate permutation for that specificity group. This helps ensure that invention features of equal importance are included in approximately equal amounts in each specificity group, and that invention features of greater importance are included more often than invention features of lesser importance.

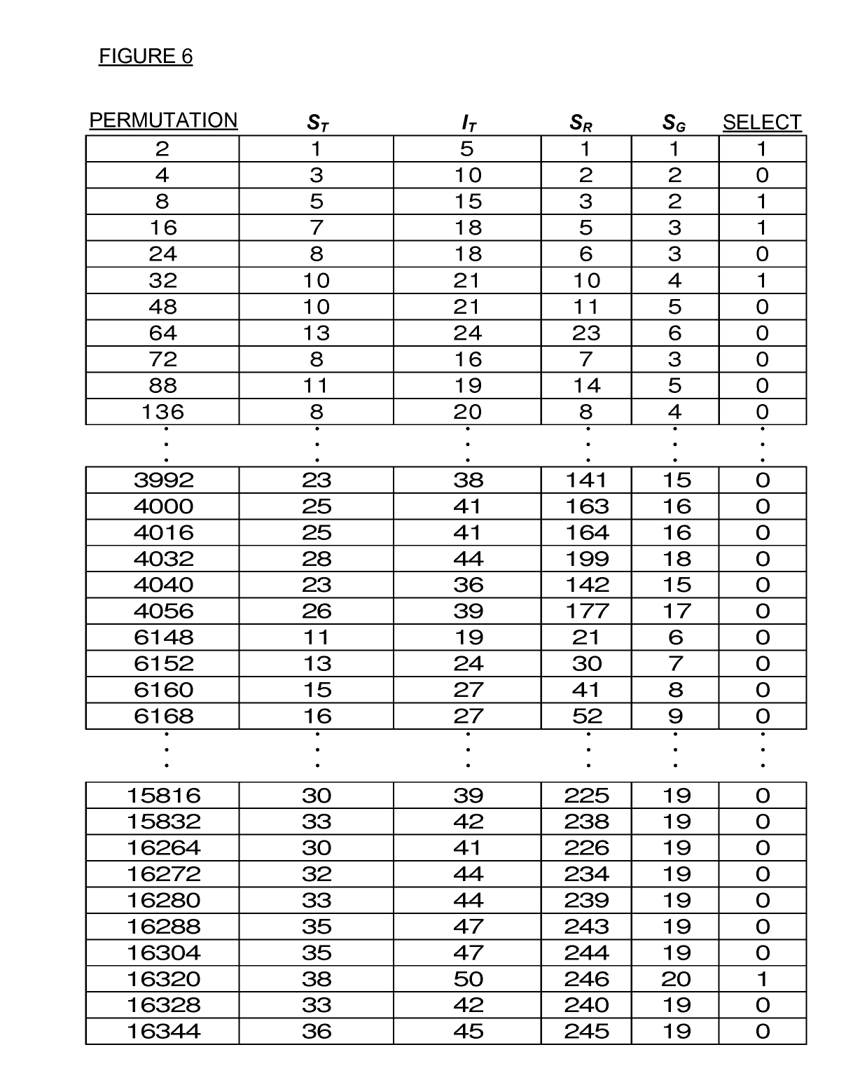

For example, as seen in FIG. 5, the specificity group for which S_{G}=1 contains only one permutation, namely permutation number 2. Permutation number 2 is selected as the best candidate permutation for the specificity group for which S_{G}=1 by allocating a Select=1 attribute thereto as shown in FIG. 6 (which shows the permutations in numerical order, not in ascending order of their overall specificity rank S_{R} values).

The FIG. 5 specificity group for which S_{G}=2 contains two permutations, namely permutation numbers 4 and 8, which have total importance I_{T} values of 10 and 15 respectively. Permutation number 8 is accordingly selected as the best candidate permutation for the specificity group for which S_{G}=2 by allocating a Select=1 attribute thereto as shown in FIG. 6. Permutation number 4 is deselected by allocating a Select=0 attribute thereto. The Select attribute simplifies subsequent identification of the permutation having the highest importance within each specificity group.

The FIG. 5 specificity group for which S_{G}=3 contains four permutations, namely permutation numbers 2052, 16, 24 and 72 which have total importance I_{T} values of 15, 18, 18 and 16 respectively. The highest of those four importance values is 18, so either one of permutations 16 or 24 can be selected as the best candidate permutation for the specificity group for which S_{G}=3. In FIG. 6, permutation 16 is selected as the best candidate permutation for the specificity group for which S_{G}=3 by allocating a Select=1 attribute thereto, and the remaining permutations within that group are deselected by allocating a Select=0 attribute to each one of them.

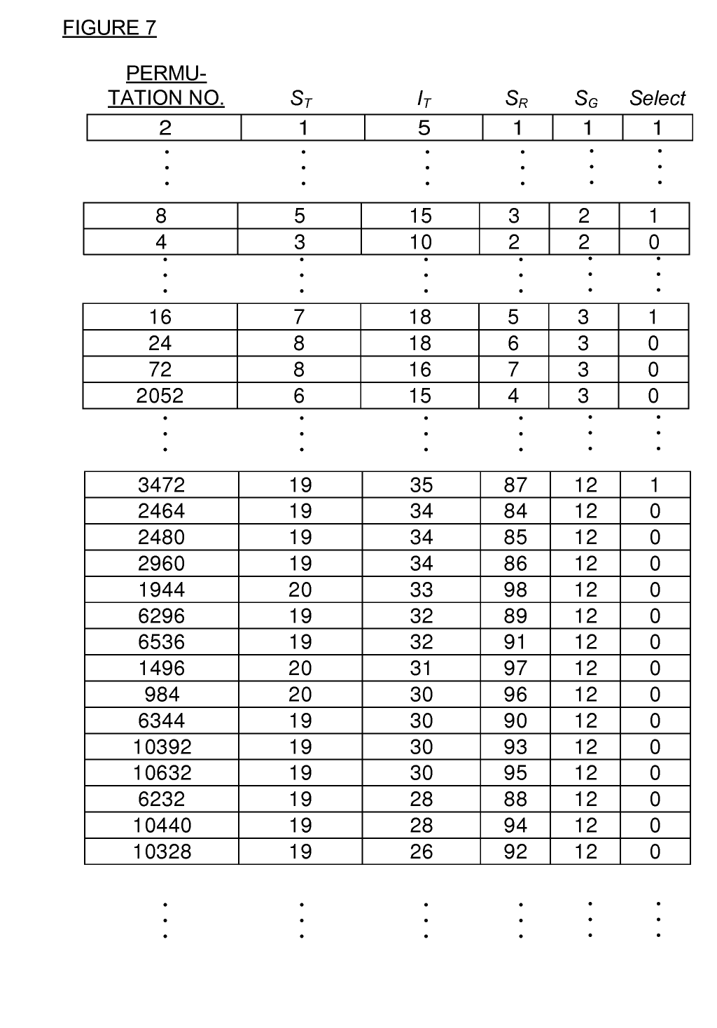

FIG. 7 depicts rearrangement of the candidate permutations within each specificity group in descending order of total importance I_{T}; after allocation of a Select=1 attribute to one candidate permutation within each group for which the total importance I_{T} value is greater than or equal to the total importance I_{T} value of any other permutation within that group; and after allocation of a Select=0 attribute to the remaining permutations within each group. Computer software can be used to rearrange the permutations within each specificity group as aforesaid, for example by sorting the permutations within each specificity group in descending order of the Select attribute, such that permutations having a Select=1 attribute will appear at the top of each specificity group as shown in FIG. 7.

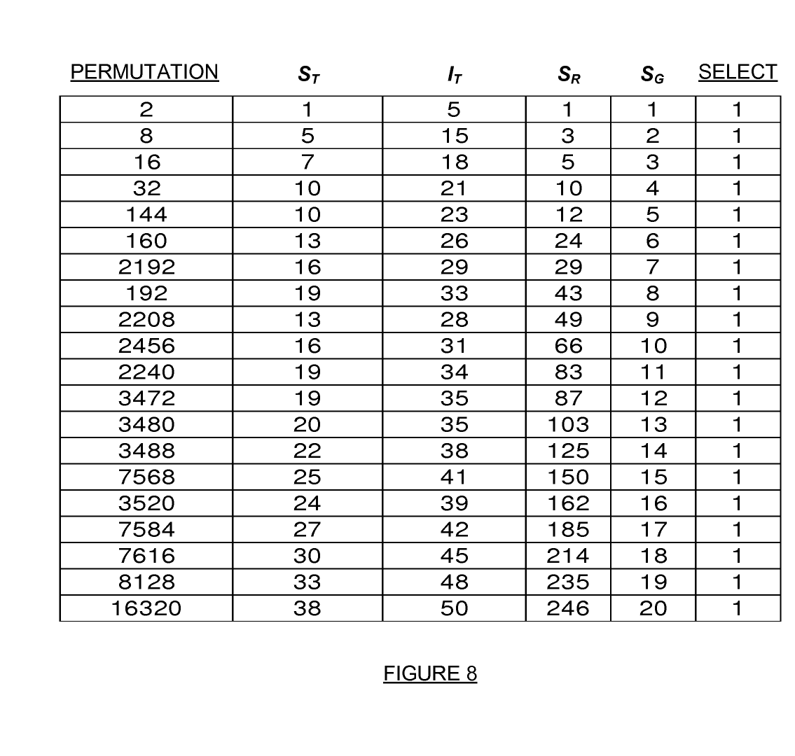

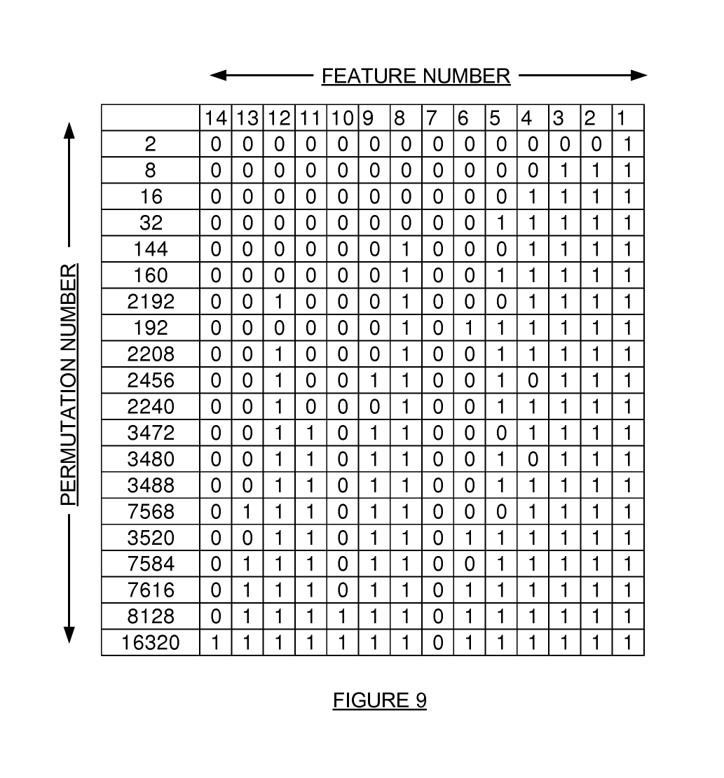

The FIG. 7 permutations having a Select=1 attribute are then selected as the permutations to be used in structuring claims for a patent application. In the case of the foregoing hypothetical example, this yields the 20 permutations shown in FIG. 8. FIG. 9 shows the invention features contained in each one of those 20 permutations. Table 3 shows one possible set of hypothetical claims 1-20 corresponding to the Table 2 invention feature permutations shown in FIGS. 8 and 9. In Table 3 the column heading Pᵢ indicates the permutation number as shown in FIGS. 8 and 9 and the column heading Cᵢ reflects sequential renumbering of the hypothetical claims.

TABLE 3
Hypothetical Claims For the Wheel Invention

| Pᵢ | Cᵢ | Claim Text |
|---|---|---|
| 2 | 1 | A disc having a central axle. |
| 8 | 2 | A disc as defined in claim 1, circumferentially surrounded |
| | | by a replaceable rubber tire. |
| 16 | 3 | A disc as defined in claim 2, wherein the rubber is latex |
| | | rubber. |
| 32 | 4 | A disc as defined in claim 3, wherein the rubber contains |
| | | carbon black. |
| 144 | 5 | A disc as defined in claim 3, wherein the tire is |
| | | pneumatically inflatable. |
| 160 | 6 | A disc as defined in claim 4, wherein the tire is |
| | | pneumatically inflatable. |
| 2192 | 7 | A disc as defined in claim 5, wherein a tread is formed in |
| | | the tire. |
| 192 | 8 | A disc as defined in claim 6, wherein the rubber is |
| | | vulcanized. |
| 2208 | 9 | A disc as defined in claim 6, wherein a tread is formed in |
| | | the tire. |
| 2456 | 10 | A disc as defined in claim 2, wherein the rubber contains |
| | | carbon black, the tire contains a pneumatically inflatable |
| | | tube, and a tread is formed in the tire. |
| 2240 | 11 | A disc as defined in claim 8, wherein a tread is formed in |
| | | the tire. |
| 3472 | 12 | A disc as defined in claim 7, wherein the tire contains an |
| | | inflation tube having a replaceable cap. |
| 3480 | 13 | A disc as defined in claim 10, wherein the inflation tube has |
| | | a replaceable cap. |
| 3488 | 14 | A disc as defined in claim 12, wherein the rubber contains |
| | | carbon black. |
| 7568 | 15 | A disc as defined in claim 12, wherein the tread has a |
| | | herringbone shape. |
| 3520 | 16 | A disc as defined in claim 14, wherein the rubber is |
| | | vulcanized. |
| 7584 | 17 | A disc as defined in claim 14, wherein the tread has a |
| | | herringbone shape. |
| 7616 | 18 | A disc as defined in claim 16, wherein the tread has a |
| | | herringbone shape. |
| 8128 | 19 | A disc as defined in claim 18, wherein the tube has an air |
| | | inlet valve. |
| 16320 | 20 | A disc as defined in claim 19, wherein the tread has an |
| | | elliptical sections shape. |

Table 3 contains some claims of broad scope (e.g. claims 1-3), some claims of narrow scope (e.g. claims 17-20), and some claims of uniformly ranging intermediate scope (e.g. claims 4-16).

Note that the Table 2 invention feature number 7 “rubber is neoprene rubber” is not included in any of the invention feature permutations shown in FIGS. 8 and 9, and is therefore not reflected in any of the Table 3 hypothetical claims. As previously explained, invention feature number 7 has a very low importance rank value I=1 since neoprene rubber is expensive and is impractical for use in tires. This illustrates how the above-described technique excludes invention features of low importance from claim sets containing a relatively low number of claims (e.g. 20 claims).

The importance rank I of a particular invention feature can be increased (or decreased) if it is desired to force the inclusion (or exclusion) of that particular feature in a set of claims for any reason. One may also adjust the importance rank values to ensure that every invention feature will appear at least once in at least one claim, although the capability to make such adjustments and retain permutations corresponding to claims of broad, narrow and intermediate scope will depend on the number of desired claims and on the number of invention features. The specificity rank values, the importance rank values, and the desired number of claims L, can also be adjusted to produce different claim sets which a patent practitioner may compare and evaluate as an aid to preparation or prosecution of a patent application.

One may also allocate more than one importance rank value to each invention feature, in order to bias the selection of invention feature permutations in accordance with different types of importance characteristics such as commercial importance, importance in terms of the ability of an invention feature to distinguish a prior art reference, importance in terms of cost, importance in terms of implementation difficulty, etc. This facilitates focusing on different aspects of commercial importance which may be related to the perceived profit potential of different invention feature permutations.

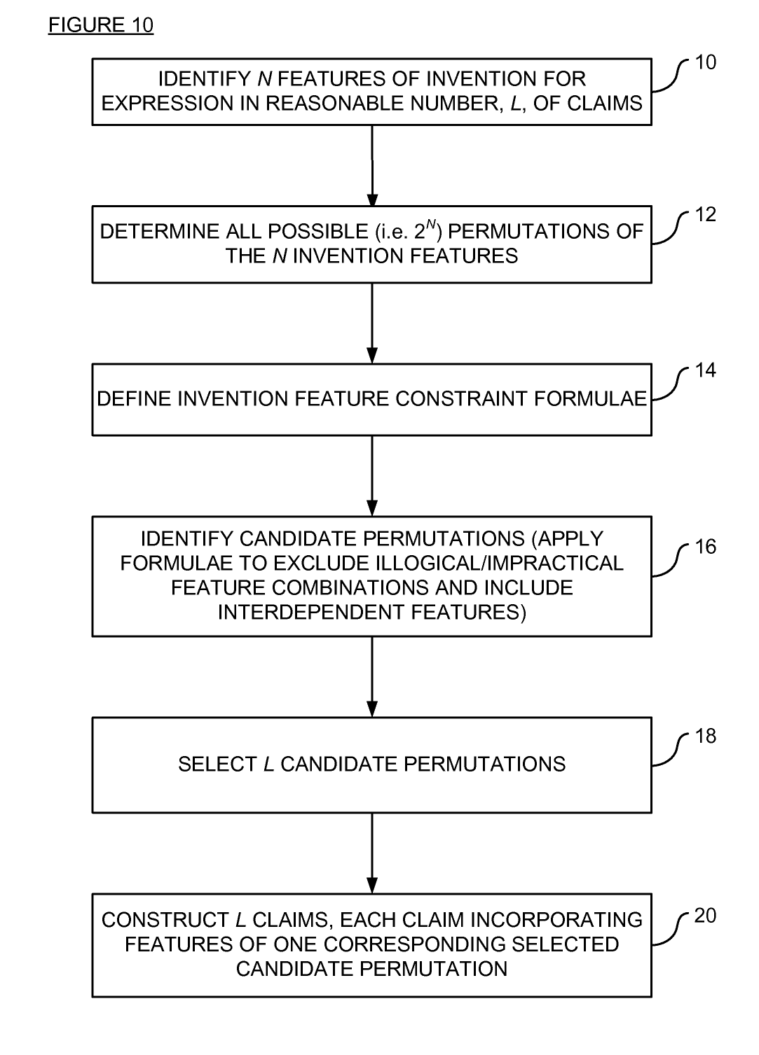

In general, and as shown in FIG. 10, a patent claim structure is devised by initially identifying a number, N, of invention features which are to be expressed in a desired reasonable number, L, of claims (FIG. 10, box 10). In the foregoing hypothetical example N=14 and L=20.

A set of all possible permutations of the N invention features is then constructed (FIG. 10, box 12). The set will contain 2^{N} unique permutations. In the foregoing hypothetical example there are 2^{N}=2¹⁴=16,384 possible permutations of the N=14 invention features.

Each invention feature is then considered in relation to all of the other invention features to determine whether the feature under consideration does or does not require one or more of the other features in order to satisfy patent claim formalities requirements. A set of constraint formulae is then defined to reflect interdependent invention feature permutations which should be included, and to also reflect permutations which are impractical or illogical and should be excluded (FIG. 10, box 14).

The constraint formulae are then applied to the 2^{N} unique permutations to identify permutations which are impractical or illogical. All such impractical or illogical permutations are excluded, leaving only those invention feature permutations which are logical, practical candidates for structuring patent application claims (FIG. 10, box 16). In the foregoing hypothetical example there are 246 such candidate permutations.

A number, L, of the candidate permutations is selected (FIG. 10, box 18) where L is the desired reasonable number of claims. In the foregoing hypothetical example L=20 candidate permutations are selected.

One claim is then constructed for each one of the L selected candidate permutations, such that each constructed claim incorporates the invention features of a corresponding one of the L selected candidate permutations (FIG. 10, box 20). Such incorporation may be direct, e.g. via an independent claim containing all of the invention features of the corresponding one of the L selected candidate permutations. Alternatively, such incorporation may be indirect, e.g. via one or more dependent claims which collectively contain all of the invention features of the corresponding one of the L selected candidate permutations.

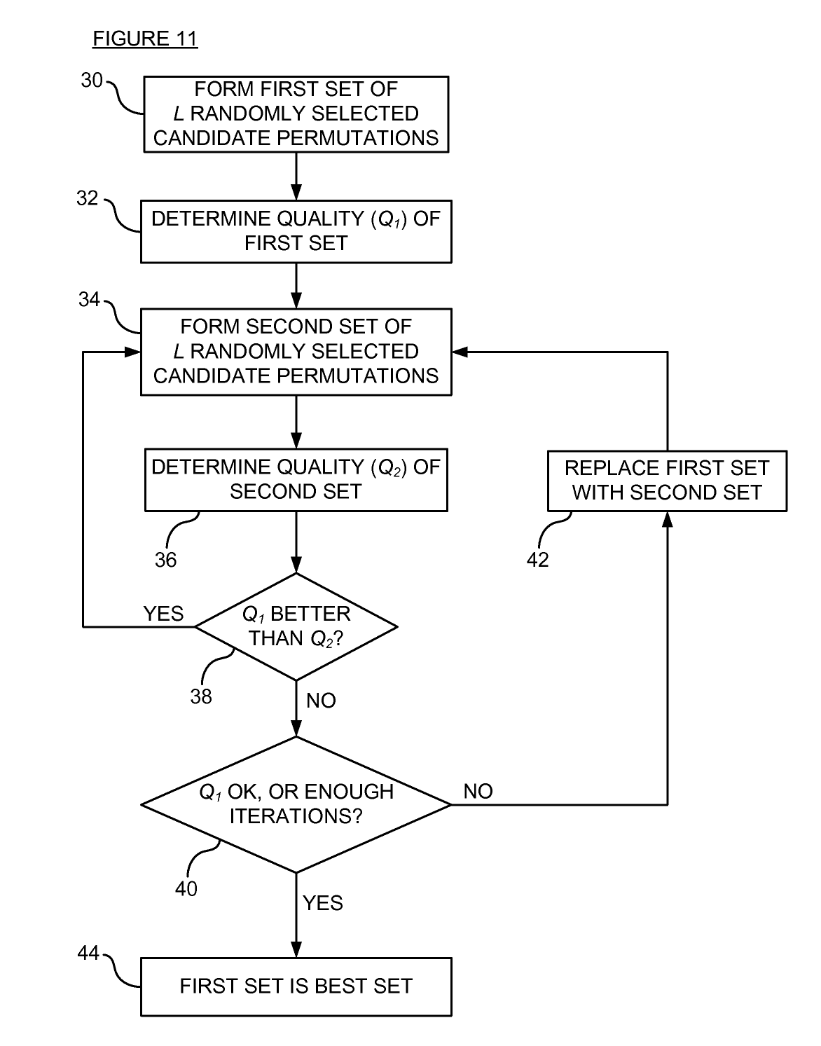

FIG. 11 illustrates a technique for selecting candidate permutations as mentioned above in relation to FIG. 10, box 18. A first set consisting of L randomly selected ones of the candidate permutations is formed (FIG. 11, box 30). In one embodiment, the first set of randomly selected candidate permutations can be used to construct L claims as mentioned above in relation to FIG. 10, box 20.

In another embodiment, as illustrated in FIG. 11, the “quality” Q₁, of the first set of randomly selected candidate permutations is determined in accordance with a predefined quality factor or factors (FIG. 11, box 32). A second set consisting of another L randomly selected ones of the candidate permutations is then formed (FIG. 11, box 34) and the “quality” Q2, of the second set is determined in accordance with the predefined quality factor(s) (FIG. 11, box 36).

Q₁ and Q₂ are then compared (FIG. 11, box 38) to determine whether the quality of the first set is better than the quality of the second set. If the FIG. 11, box 38 operation result is affirmative (i.e. if Q₁ is better than Q₂: FIG. 11, box 38, “yes” output) then the FIG. 11, box 34 operation is repeated to form another second set consisting of another L randomly selected ones of the candidate permutations. The FIG. 11, box 36 and 38 operations are then performed again, as previously described.

If the FIG. 11, box 38 operation result is negative (i.e. if Q₁ is not better than Q₂: FIG. 11, box 38, “no” output) then Q₁ is compared (FIG. 11, box 40) with a predefined quality threshold to determine whether Q₁ meets or exceeds the threshold. Another comparison can also be performed (FIG. 11, box 40) to determine whether the number of iterative repetitions of the FIG. 11, box 34, 36 and 38 operations exceeds a predefined iteration threshold. If either of the FIG. 11, box 40 comparison results are affirmative (i.e. if Q₁ meets or exceeds the quality threshold, or if the iteration threshold is reached: FIG. 11, box 40, “yes” output) then the first set of L randomly selected candidate permutations is selected (FIG. 11, box 42) as the best set for claim construction (FIG. 10, box 20).

If both of the FIG. 11, box 40 comparison results are negative (i.e. if Q₁ does not meet the quality threshold, and if the iteration threshold has not been reached: FIG. 11, box 40, “no” output) then the first set is replaced with the second set (FIG. 11, box 42). Skilled persons will understand that “replacement” may in some cases require only updating of a pointer, as opposed to overwriting of the first set with the second set. After completion of the FIG. 11, box 42 operation, the first set will have the highest quality of any of the sets considered thus far. The FIG. 11, box 34 operation is then repeated to form another second set consisting of another L randomly selected ones of the candidate permutations. The FIG. 11, operations are then performed again commencing with box 36, as previously described, until a best set is selected (FIG. 11, box 44).

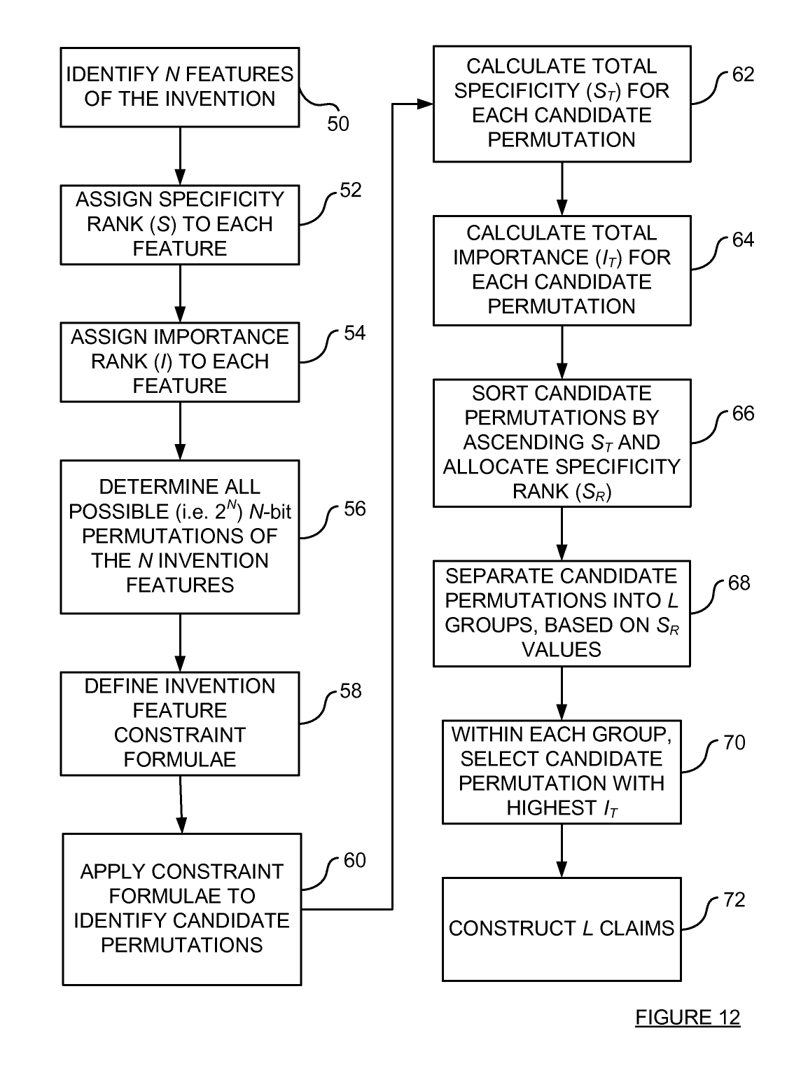

FIG. 12 illustrates an alternative technique for selecting candidate permutations as mentioned above in relation to FIG. 10, box 18. To avoid confusion, this alternative technique is described in conjunction with the previously described FIG. 10 operations. Initially, a number, N, of invention features which are to be expressed in a desired reasonable number, L, of claims are identified (FIG. 12, box 50 and FIG. 10, box 10).

Each invention feature is assigned a numerically expressed specificity rank S (FIG. 12, box 52) and a numerically expressed importance rank I (FIG. 12, box 54). S and I may each be integers within a predefined range. In the foregoing hypothetical example, 1≦S≦5 where 1 denotes the broadest and 5 denotes the narrowest specificity; and 1≦I≦5 where 1 denotes the lowest and 5 denotes the highest importance.

A set of all possible (i.e. 2^{N}) permutations of the N invention features is constructed (FIG. 12, box 56 and FIG. 10, box 12).

Constraint formulae are defined, as previously explained, to reflect interdependent invention feature permutations which should be included, and to also reflect permutations which are impractical or illogical and should be excluded (FIG. 12, box 58 and FIG. 10, box 14). The constraint formulae are applied to the 2^{N} unique permutations to identify permutations which are impractical or illogical. All such impractical or illogical permutations are excluded, leaving only those invention feature permutations which are logical, practical candidates for structuring patent application claims (FIG. 12, box 60 and FIG. 10, box 16).

The specificity rank values of the invention features included in each candidate permutation are then summed to derive a total specificity S_{T} for each candidate permutation (FIG. 12, box 62). The importance rank values of the invention features included in each candidate permutation are also summed to derive a total importance I_{T} for each candidate permutation (FIG. 12, box 64).

The candidate permutations are then sorted in order of increasing total specificity S_{T}, and permutations having the same total specificity S_{T} are further sorted in ascending permutation number order. Each sorted candidate permutation is allocated a sequential overall specificity rank S_{R} value (FIG. 12, box 66). In the foregoing hypothetical example, the overall specificity rank S_{R} values range from 1 to 246.

The candidate permutations are then separated into L specificity groups, based on the permutations' overall specificity rank S_{R} values (FIG. 12, box 68). As previously explained, the separation operation may be implemented in various ways, such as selecting candidate permutations having S_{R} values which differ by an equal amount, or selecting candidate permutations based upon the square roots of their S_{R} values.

Within each specificity group, the candidate permutation having the highest total importance within that group is selected as the best candidate permutation for that group (FIG. 12, box 70 and FIG. 10, box 18). This yields L candidate permutations, which are used to construct claims as previously explained (FIG. 12, box 72 and FIG. 10, box 20).

While a number of exemplary aspects and embodiments have been discussed above, various modifications are possible. For example, computer software can be used to generate a textual representation of each candidate permutation, to provide a guide for structuring patent application claims corresponding to the candidate permutations. Each permutation can be represented textually by concatenating or hierarchically concatenating the corresponding Table 2 invention features. As an example, the FIG. 9 row 2208 permutation “00100010011111” corresponds to a claim containing the Table 2 invention features numbered 1, 2, 3, 4, 5, 8 and 12. Those features can be textually represented by concatenating the corresponding Table 2 text as “wheel+wheel has replaceable tire+tire is made of rubber+rubber is latex rubber+rubber contains carbon black+tire is pneumatic+tire has tread”. Those features can also or alternatively be textually represented by hierarchically concatenating the corresponding Table 2 text as follows:
1 wheel
2 wheel has replaceable tire
3 tire is made of rubber
4 rubber is latex rubber
5 rubber contains carbon black
8 tire is pneumatic
12 tire has tread
   A patent practitioner can readily convert either of the foregoing textual representations into a patent application claim, for example Table 3 hypothetical claim 9 (recognizing that claim 9 is expressed in dependent form).

As another example, computer software can be used to generate a textual representation of a pseudo-claim structure corresponding to a set of candidate permutations, to provide another convenient guide for structuring patent application claims corresponding to the candidate permutations. For example, as previously explained, the row 2 permutation “00000000000001” corresponds to a claim containing only Table 2's “wheel” feature number 1. Similarly, the row 8 permutation “00000000000111” corresponds to a claim containing Table 2's “wheel” feature number 1 and also containing Table 2's “wheel has replaceable tire” feature number 2 and also containing Table 2's “tire is made of rubber” feature number 3. The row 2 permutation thus corresponds to an independent claim containing only Table 2's “wheel” feature number 1, and the row 8 permutation corresponds to a claim which depends from that independent claim and which also includes the limitations “wheel has replaceable tire” and “tire is made of rubber”. The row 16 permutation “00000000001111” corresponds to a claim containing Table 2's “wheel”, “wheel has replaceable tire”, “tire is made of rubber” and “rubber is latex rubber” feature numbers 1 through 4. The row 16 permutation thus corresponds to a claim which depends from the dependent claim corresponding to the row 8 permutation and which also includes the limitation “rubber is latex rubber”.

Skilled persons will understand that computer software can be configured or developed to identify such dependent relationships within a set of candidate permutations and to output a textual representation of a pseudo-claim structure embodying such relationships, for example as shown in Table 4. In Table 4 the column heading Pᵢ indicates the permutation number as shown in FIGS. 8 and 9 and the column heading Cᵢ reflects sequential renumbering of the hypothetical claims.

TABLE 4
Pseudo-Claims For the Wheel Invention

| Pᵢ | Cᵢ | Pseudo-Claim Text |
|---|---|---|
| 2 | 1 | wheel |
| 8 | 2 | Claim 1 + wheel has replaceable tire + tire is made of |
| | | rubber. |
| 16 | 3 | Claim 2 + rubber is latex rubber. |
| 32 | 4 | Claim 3 + rubber contains carbon black. |
| 144 | 5 | Claim 3 + tire is pneumatic. |
| 160 | 6 | Claim 4 + tire is pneumatic. |
| 2192 | 7 | Claim 5 + tire has tread. |
| 192 | 8 | Claim 6 + rubber is vulcanized. |
| 2208 | 9 | Claim 6 + tire has tread. |
| 2456 | 10 | Claim 2 + rubber contains carbon black + tire is |
| | | pneumatic + tire has inflation tube + tire has tread. |
| 2240 | 11 | Claim 8 + tire has tread. |
| 3472 | 12 | Claim 7 + tire has inflation tube + inflation tube has |
| | | replaceable cap. |
| 3480 | 13 | Claim 10 + inflation tube has replaceable cap. |
| 3488 | 14 | Claim 12 + + rubber contains carbon black. |
| 7568 | 15 | Claim 12 + tread has herringbone shape. |
| 3520 | 16 | Claim 14 + rubber is vulcanized. |
| 7584 | 17 | Claim 14 + tread has herringbone shape. |
| 7616 | 18 | Claim 16 + tread has herringbone shape. |
| 8128 | 19 | Claim 18 + inflation tube has valve. |
| 16320 | 20 | Claim 19 + tread has elliptical sections shape. |

A patent practitioner can readily utilize the Table 4 pseudo-claim structure to draft a set of patent application claims, for example as shown in Table 3.

A computerizable technique for identifying dependent relationships within a set of invention feature permutations like those depicted in FIG. 9 is now described. As previously explained, the first FIG. 9 permutation, i.e. the row 2 permutation “00000000000001”, corresponds to a claim containing only Table 2's invention feature number 1 “wheel”. The row 2 permutation is identified as corresponding to a first claim, i.e. an independent claim 1 reflecting the “wheel” invention feature. A corresponding pseudo-claim 1 textually represented as “wheel” can be output, as shown in Table 4, and a patent practitioner can readily utilize the output pseudo-claim to draft a corresponding independent claim 1, e.g. “A disc having a central axle.” as shown in Table 3.

The next FIG. 9 permutation, i.e. the row 8 permutation “00000000000111”, is then compared to the row 2 permutation to determine whether the row 8 permutation has any invention features in common with the row 2 permutation. A bitwise logical “AND” operation can be used to compare two permutations and determine whether they have any common invention features. For example, a bitwise “AND” operation performed between the row 2 permutation “00000000000001” and the row 8 permutation “00000000000111” yields “00000000000001”, indicating that the row 2 permutation and the row 8 permutation have Table 2's “wheel” feature number 1 in common. The row 8 permutation is accordingly identified as corresponding to a second claim, i.e. a claim 2 dependent upon the previously identified claim 1. Features which the row 8 permutation does not have in common with the row 2 permutation, namely feature 2 “wheel has replaceable tire” and feature 3 “tire is made of rubber” are directly recited in claim 2. Features which the row 8 permutation has in common with the row 2 permutation, namely feature 1 “wheel” are indirectly encompassed via dependency of claim 2 upon claim 1. A corresponding pseudo-claim 2 textually represented as “Claim 1+wheel has replaceable tire+tire is made of rubber” can be output, as shown in 4. A patent practitioner can readily utilize the output pseudo-claim to draft a corresponding dependent claim 2, e.g. “A disc as defined in claim 1, circumferentially surrounded by a replaceable rubber tire.” as shown in Table 3.

The next FIG. 9 permutation, i.e. the row 16 permutation “00000000001111”, is then compared to each of the preceding FIG. 9 permutations (i.e. the row 2 permutation and the row 8 permutation) to determine whether the row 16 permutation has any invention features in common with any of the preceding FIG. 9 permutations, and if so, which of the preceding FIG. 9 permutations has the most invention features in common with the row 16 permutation. A bitwise “AND” performed between the row 2 permutation “00000000000001” and the row 16 permutation “00000000001111” yields “00000000000001”, indicating that the row 2 and 16 permutations have Table 2's “wheel” feature 1 in common. A bitwise “AND” performed between the row 8 permutation “00000000000111” and the row 16 permutation “00000000001111” yields “00000000000111”, indicating that the row 8 and 16 permutations have features 1, 2 and 3 in common. Since the row 16 permutation has more features in common with the row 8 permutation than with the row 2 permutation, the row 16 permutation is identified as corresponding to a third claim, i.e. a claim 3 dependent upon the previously identified claim 2. Features which the row 16 permutation does not have in common with the row 8 permutation, namely feature 4 “rubber is latex rubber” are directly recited in claim 3. Features which the row 16 permutation has in common with the row 8 permutation, namely feature 3 “tire is made of rubber”, feature 2 “wheel has replaceable tire” and feature 1 “wheel” are indirectly encompassed via dependency of claim 3 upon claim 2 and via dependency of claim 2 upon claim 1. A corresponding pseudo-claim 3 textually represented as “Claim 2+rubber is latex rubber” can be output, as shown in 4. A patent practitioner can readily utilize the output pseudo-claim to draft a corresponding dependent claim 3, e.g. “A disc as defined in claim 2, wherein the rubber is latex rubber.” as shown in Table 3.

The next FIG. 9 permutation, i.e. the row 32 permutation “00000000011111”, is then compared to each of the preceding FIG. 9 permutations (i.e. the row 2, 8 and 16 permutations) to determine whether the row 32 permutation has any invention features in common with any of the preceding FIG. 9 permutations, and if so, which of the preceding FIG. 9 permutations has the most invention features in common with the row 32 permutation. Bitwise “AND” operations performed between the row 32 permutation and each of the row 2, 8 and 16 permutations yield “00000000000001”, “00000000000111” and “00000000001111” respectively indicating that the row 2 and 32 permutations have feature 1 in common; the row 8 and 32 permutations have features 1, 2 and 3 in common; and the row 16 and 32 permutations have features 1, 2, 3 and 4 in common. Since the row 32 permutation has more features in common with the row 16 permutation than with either of the row 2 or row 8 permutations, the row 32 permutation is identified as corresponding to a fourth claim, i.e. a claim 4 dependent upon the previously identified claim 3. Features which the row 32 permutation does not have in common with the row 16 permutation, namely feature 5 “rubber contains carbon black” are directly recited in claim 4. Features which the row 32 permutation has in common with the row 16 permutation, namely feature 4 “rubber is latex rubber”, feature 3 “tire is made of rubber”, feature 2 “wheel has replaceable tire” and feature 1 “wheel” are indirectly encompassed via dependency of claim 4 upon claim 3, dependency of claim 3 upon claim 2 and dependency of claim 2 upon claim 1. A corresponding pseudo-claim 4 textually represented as “Claim 3+rubber contains carbon black” can be output, as shown in 4. A patent practitioner can readily utilize the output pseudo-claim to draft a corresponding dependent claim 4, e.g. “A disc as defined in claim 3, wherein the rubber contains carbon black.” as shown in Table 3.

The next FIG. 9 permutation, i.e. the row 144 permutation “00000010001111”, is then compared to each of the preceding FIG. 9 permutations (i.e. the row 2, 8, 16 and 32 permutations) to determine whether the row 144 permutation has any invention features in common with any of the preceding FIG. 9 permutations, and if so, which of the preceding FIG. 9 permutations has the most invention features in common with the row 144 permutation. Bitwise “AND” operations performed between the row 144 permutation and each of the row 2, 8, 16 and 32 permutations yield “00000000000001”, “00000000000111”, “00000000001111” and “00000000001111”, respectively indicating that the row 2 and 144 permutations have feature 1 in common; the row 8 and 144 permutations have features 1, 2 and 3 in common; and both of the row 16 and 32 permutations have features 1, 2, 3 and 4 in common with the row 144 permutation. Since the row 144 permutation has more features in common with the row 16 and 32 permutations than with either of the row 2 or row 8 permutations, the row 144 permutation is identified as corresponding to a fifth claim, i.e. a claim 5 dependent upon the previously identified claim 3. (Claim 5 could alternatively be made dependent upon the previously identified claim 4.) Features which the row 144 permutation does not have in common with the row 16 permutation, namely feature 8 “tire is pneumatic” are directly recited in claim 5. Features which the row 144 permutation has in common with the row 16 permutation, namely feature 4 “rubber is latex rubber”, feature 3 “tire is made of rubber”, feature 2 “wheel has replaceable tire” and feature 1 “wheel” are indirectly encompassed via dependency of claim 5 upon claim 3, dependency of claim 3 upon claim 2 and dependency of claim 2 upon claim 1. A corresponding pseudo-claim 5 textually represented as “Claim 3+tire is pneumatic” can be output, as shown in 4. A patent practitioner can readily utilize the output pseudo-claim to draft a corresponding dependent claim 5, e.g. “A disc as defined in claim 3, wherein the tire is pneumatically inflatable.” as shown in Table 3.

The remaining FIG. 9 permutations are similarly sequentially compared to their respectively preceding FIG. 9 permutations to identify dependent relationships for each of the remaining FIG. 9 permutations and to output pseudo-claim textual representations thereof. The FIG. 9 permutations can be represented by one independent claim and 19 dependent claims, as shown in Tables 3 and 4. However those of skill in the art will understand that situations may arise in which no dependent relationships will be identifiable for one or more permutations, depending upon the number of invention features N, the desired number of claims L, the specificity rank Sᵢ and the importance rank Iᵢ of the respective invention features. In such case further independent claims, and claims depending therefrom, can be constructed substantially as previously described.

Those of skill in the art will recognize further modifications, permutations, additions and sub-combinations of the foregoing exemplary aspects and embodiments are possible. For example, as of February 2010 Canada does not levy claims-based fees, so a Canadian patent application may contain a large number of claims. If it is desired to file a corresponding foreign patent application claiming priority on the Canadian application, it may be desirable to reduce the number of claims in the foreign application to reduce claims-based fees in any country which levies such fees. Similarly, as of February 2010 the World Intellectual Property Organization does not levy claims-based fees in respect of international patent applications filed pursuant to the Patent Cooperation Treaty, so a PCT application may contain a large number of claims. If it is desired to pursue national or regional phase entry of a PCT application in any country or region which levies claims-based fees, it may be desirable to reduce the number of claims in national or regional counterparts of the PCT application to reduce claims-based fees in such countries or regions.

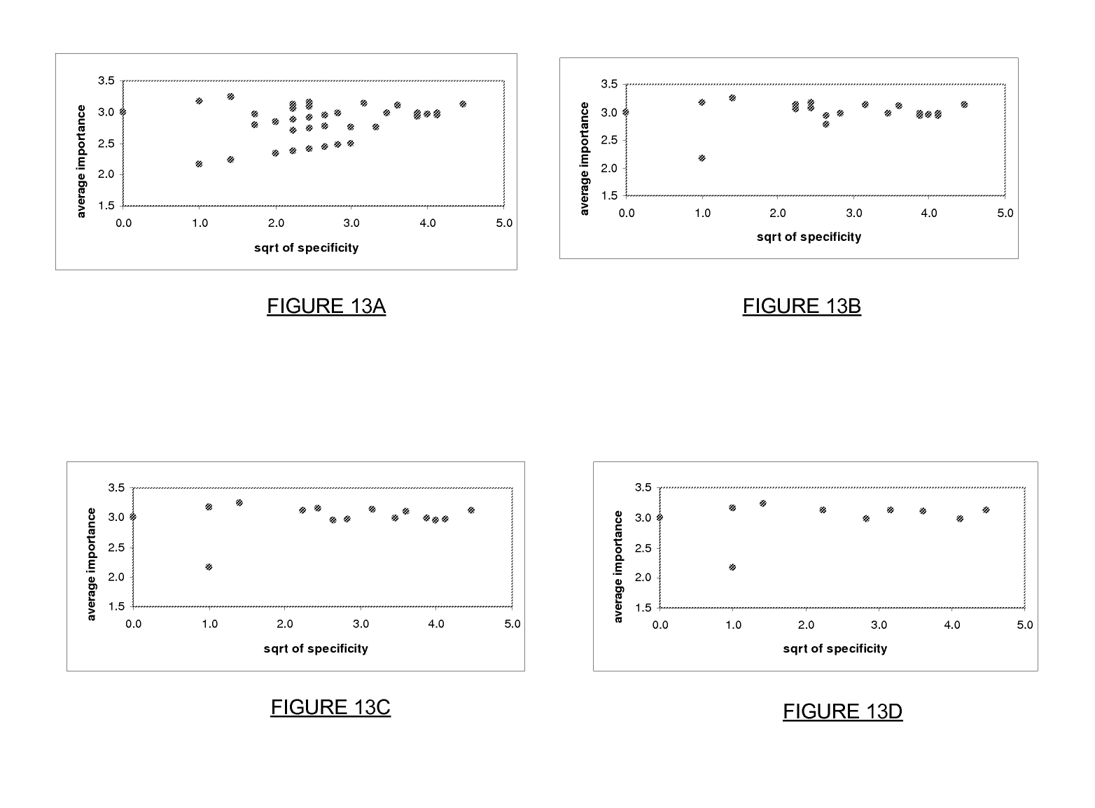

FIG. 13A is a scatter plot graphically depicting a set of 43 claims directed to an invention having 20 invention features to which specificity and importance ranks were assigned as aforesaid. For each claim, the square root of the total specificity rank Sᵢ of all of the invention features included in the claim is plotted along the graph's horizontal axis; and the average value of the importance rank Iᵢ of all of the invention features included in the claim is plotted along the graph's vertical axis. The FIG. 13A graph includes 43 data plot points, each corresponding to one of the 43 claims. In some cases two or more data plot points may overlap, making if difficult to see all 43 data plot points in FIG. 13A.

FIG. 13B depicts a scatter plot obtained by removing 23 of the data plot points shown in FIG. 13A, leaving 20 data plot points. Such removal can be accomplished by selecting different regions of the FIG. 13A scatter plot which contain equal or approximately equal numbers of data plot points and which therefore correspond to equal or approximately equal numbers of claims. For example, four such regions can be selected, by notionally vertically dividing the FIG. 13A scatter plot into four horizontally adjacent regions containing equal or approximately equal numbers of data plot points. An importance threshold value is predefined for each region, it being understood that each region may have a different threshold value. Within each region, data plot points corresponding to claims for which the average values of the importance rank Iᵢ of all of the invention features included in the claim are less than the region's predefined importance threshold value are removed, yielding the FIG. 13B scatter plot. The 20 data plot points remaining in FIG. 13B correspond to claims which have somewhat higher average importance rank values and somewhat uniformly distributed specificity. Skilled persons will understand that computer software can be configured or developed to identify and remove from an existing claim set claims which do not meet threshold criteria as aforesaid, yielding a reduced claim set having somewhat higher average total importance rank values and somewhat more uniformly distributed specificity values than the existing claim set.

FIG. 13C depicts a scatter plot obtained by removing 28 of the data plot points shown in FIG. 13A, leaving 15 data plot points. This can be accomplished in a manner similar to that described above in relation to FIG. 13B by predefining somewhat higher average importance threshold values for one or more of the regions than the corresponding threshold values used to select the 20 data plot points shown in FIG. 13B. The 15 data plot points remaining in FIG. 13C thus correspond to claims which have somewhat higher average importance rank values and a somewhat more uniform specificity distribution than the claims corresponding to the 20 FIG. 13B data plot points.

FIG. 13D depicts a scatter plot obtained by removing 33 of the data plot points shown in FIG. 13A, leaving 10 data plot points. This can also be accomplished in a manner similar to that described above in relation to FIG. 13B by predefining still higher average importance threshold values for one or more of the regions than the corresponding threshold values used to select the 15 data plot points shown in FIG. 13C. The 10 data plot points remaining in FIG. 13D thus correspond to claims which have somewhat higher average importance rank values and a somewhat more uniform specificity distribution than the claims corresponding to the 15 FIG. 13C data plot points.

It is therefore intended that the following appended claims and claims hereafter introduced are to be interpreted to include all such modifications, permutations, additions and sub-combinations as are within their true spirit and scope.

What is claimed is:

1. A computer-implemented method of identifying textually representable permutations of an integer number, N, of features characterizing an invention, each identified permutation corresponding to one of a desired number, L, of claims to be included in an application to patent the invention, the method comprising the steps of:
forming a plurality of initial permutations, each initial permutation representative of one or more of the invention features;
defining constraints representative of:
interdependent invention features, and
invention feature combinations which are impractical or illogical;
applying the constraints to the initial permutations to identify an integer number, P_{T}, of candidate permutations which exclude impractical or illogical invention feature combinations and include interdependent invention features;
selecting L of the candidate permutations; and
textually representing each one of the L selected candidate permutations.

2. A computer-implemented method as defined in claim 1, wherein selecting L of the candidate permutations further comprises randomly selecting L of the candidate permutations.

3. A computer-implemented method as defined in claim 1, wherein selecting L of the candidate permutations further comprises:
randomly selecting a first set containing L of the candidate permutations;
determining a quality, Q₁, of the first set in accordance with a predefined quality factor;
randomly selecting a second set containing another L of the candidate permutations;
determining a quality, Q₂, of the second set in accordance with the predefined quality factor;
comparing Q₁ and Q₂ to determine whether Q₁ is better than Q₂;
if Q₁ is better than Q₂, sequentially repeating the foregoing steps commencing with the randomly selecting a second set step;
if Q₁ is not better than Q₂, comparing Q₁ with a predefined quality threshold;
if Q₁ is greater than or equal to the quality threshold, selecting the first set of candidate permutations as a basis for the claims and terminating the method;
if Q₁ is not greater than or equal to the quality threshold, substituting the second set for the first set; and
sequentially repeating the foregoing steps commencing with the randomly selecting a second set step.

4. A computer-implemented method as defined in claim 1, wherein selecting L of the candidate permutations further comprises:
initializing an iteration counter;
randomly selecting a first set containing L of the candidate permutations;
determining a quality, Q₁, of the first set in accordance with a predefined quality factor;
randomly selecting a second set containing another L of the candidate permutations;
incrementing the iteration counter;
determining a quality, Q₂, of the second set in accordance with the predefined quality factor;
comparing Q₁ and Q₂ to determine whether Q₁ is better than Q₂;
if Q₁ is better than Q₂, sequentially repeating the foregoing steps commencing with the randomly selecting a second set step;
if Q₁ is not better than Q₂, comparing the iteration counter with a predefined iteration threshold;
if the iteration counter is greater than or equal to the iteration threshold, selecting the first set of candidate permutations as a basis for the claims and terminating the method;
if the iteration counter is not greater than or equal to the iteration threshold, substituting the second set for the first set; and
sequentially repeating the foregoing steps commencing with the randomly selecting a second set step.

5. A computer-implemented method as defined in claim 1, further comprising:
assigning a specificity rank, S, and an importance rank, I, to each one of the features;
after identifying the candidate permutations, for each one of the candidate permutations:
determining a total specificity, S_{T}, for the one of the candidate permutations by summing the specificity rank, S, assigned to each one of the features included in the one of the candidate permutations;
determining a total importance, I_{T}, for the one of the candidate permutations by summing the importance rank, I, assigned to each one of the features included in the one of the candidate permutations;
sorting the candidate permutations in accordance with the total specificity, S_{T}, of each one of the candidate permutations;
allocating an overall specificity rank, S_{R}, to each one of the candidate permutations;
separating the candidate permutations into L specificity groups in accordance with the overall specificity rank, S_{R}, of each one of the candidate permutations; and
wherein selecting L of the candidate permutations comprises selecting, from each one of the L specificity groups, one candidate permutation having a total importance, I_{T}, which is greater than or equal to the total importance, I_{T}, of any other candidate permutation in the one of the L specificity groups.

6. A computer-implemented method as defined in claim 5, wherein separating the candidate permutations into L specificity groups comprises selecting, for each one of the specificity groups, candidate permutations having overall specificity ranks, S_{R}, which differ by an approximately equal amount.

7. A computer-implemented method as defined in claim 5, wherein separating the candidate permutations into L specificity groups comprises selecting candidate permutations in proportion to the square roots of the overall specificity rank, S_{R}, of the respective candidate permutations.

8. A computer-implemented method as defined in claim 7, further comprising allocating each one of the candidate permutations to a specificity group, S_{G}, in accordance with the equation:
$${S}_{G} = INT ( \sqrt{{S}_{R} - 1} \times \frac{L - 1}{\sqrt{{P}_{T} - 1}} ) + 1.$$

9. A computer-implemented method as defined in claim 1, wherein 2^{N} initial permutations of the invention features are formed.

10. A computer-implemented method as defined in claim 5, further comprising:
textually representing each one of the invention features; and
wherein textually representing each one of the L selected candidate permutations comprises concatenating the textual representations of each one of the invention features included in the one candidate permutation.

11. A computer-implemented method as defined in claim 10, further comprising hierarchically arranging the concatenated textual representations of the invention features included in the one candidate permutation in accordance with the specificity rank, S, and the importance rank, I, of the invention features included in the one candidate permutation.

12. A computer-implemented method as defined in claim 5, further comprising:
textually representing each one of the invention features;
for each one candidate permutation selected from each one of the L specificity groups, determining whether a dependency relationship exists between the one candidate permutation and any other candidate permutation previously selected from one of the L specificity groups, the dependency relationship comprising inclusion in the one candidate permutation of all invention features included in the other candidate permutation;
textually representing each one candidate permutation selected from each one of the L specificity groups by concatenating textual representations of invention features which are unique to the one candidate permutation; and
if a dependency relationship exists between the one candidate permutation and another candidate permutation, further concatenating the concatenated textual representations of invention features unique to the one candidate permutation with a textual reference to the other candidate permutation.

13. A computer-implemented method as defined in claim 12, wherein:
each permutation is an N-bit sequence in which a bit position containing a binary digit one represents presence of an invention feature corresponding to the bit position and a binary digit zero represents absence of the invention feature corresponding to the bit position;
determining whether a dependency relationship exists between the one candidate permutation and any other candidate permutation previously selected from one of the L specificity groups, comprises:
for each candidate permutation previously selected from one of the L specificity groups, forming an N-bit output sequence by performing a bitwise AND operation between the one candidate permutation and the candidate permutation previously selected from one of the L specificity groups;
comparing the N-bit output sequences to determine whether there is a particular one of the N-bit output sequences which contains a number of occurrences of the binary digit one greater than or equal to the number of occurrences of the binary digit one contained in any other one of the N-bit output sequences;
if there is a particular one of the N-bit output sequences, identifying the one candidate permutation as corresponding to a claim which:
recites invention features which the one candidate permutation does not have in common with the candidate permutation previously selected from one of the L specificity groups and which was used to form the particular one of the N-bit output sequences; and
depends upon a claim corresponding to the candidate permutation previously selected from one of the L specificity groups and which was used to form the particular one of the N-bit output sequences.

14. A computer-implemented method as defined in claim 1, further comprising:
assigning a specificity rank, Sᵢ, and an importance rank, Iᵢ, to each iₜₕ one of the features, where I is an integer and 1≦i≦N;
after identifying the candidate permutations, for each kₜₕ one of the candidate permutations, where k is an integer and 1≦k≦P_{T}:
determining a total specificity, S_{Tk}, for the kₜₕ one of the candidate permutations by summing the specificity rank, Sᵢ, assigned to each one of the features included in the kₜₕ one of the candidate permutations;
determining a total importance, I_{Tk}, for the kₜₕ one of the candidate permutations by summing the importance rank, Iᵢ, assigned to each one of the features included in the kₜₕ one of the candidate permutations;
sorting the P_{T} candidate permutations in accordance with the total specificity, S_{T}, of each one of the candidate permutations;
allocating an overall specificity rank, S_{R}, to each kₜₕ one of the candidate permutations;
separating the P_{T} candidate permutations into L specificity groups in accordance with the overall specificity rank, S_{R}, of each one of the candidate permutations; and
wherein selecting L of the candidate permutations comprises selecting, from each one of the L specificity groups, one candidate permutation having a total importance, I_{Tk}, which is greater than or equal to the total importance, I_{Tk}, of any other candidate permutation in the one of the L specificity groups.

15. A set of textually represented permutations of an integer number, N, of features characterizing an invention, each textually represented permutation corresponding to one of a desired number, L, of claims to be included in an application to patent the invention, wherein the textually represented permutations are formed by:
textually representing each one of the features;
forming a plurality of initial permutations, each initial permutation representative of one or more of the invention features;
defining constraints representative of:
interdependent invention features;
invention feature combinations which are impractical or illogical;
applying the constraints to the initial permutations to identify an integer number, P_{T}, candidate permutations which exclude impractical or illogical invention feature combinations and include interdependent invention features;
selecting L of the candidate permutations; and
textually representing each one of the L selected candidate permutations.

16. A set of textually represented permutations as defined in claim 15, wherein textually representing each one of the L selected candidate permutations further comprises concatenating the textual representations of each one of the invention features included in the one of the L selected candidate permutations.

17. A set of textually represented permutations as defined in claim 15, wherein the textually represented permutations are further formed by:
assigning a specificity rank, S, and an importance rank, I, to each one of the features;
after identifying the candidate permutations, for each one of the candidate permutations:
determining a total specificity, S_{T}, for the one of the candidate permutations by summing the specificity rank, S, assigned to each one of the features included in the one of the candidate permutations;
determining a total importance, I_{T}, for the one of the candidate permutations by summing the importance rank, I, assigned to each one of the features included in the one of the candidate permutations;
sorting the candidate permutations in accordance with the total specificity, S_{T}, of each one of the candidate permutations;
allocating an overall specificity rank, S_{R}, to each one of the candidate permutations;
separating the candidate permutations into L specificity groups in accordance with the overall specificity rank, S_{R}, of each one of the candidate permutations; and
wherein selecting L of the candidate permutations comprises selecting, from each one of the L specificity groups, one candidate permutation having a total importance, I_{T}, which is greater than or equal to the total importance, I_{T}, of any other candidate permutation in the one of the L specificity groups.

18. A set of textually represented permutations as defined in claim 17, wherein separating the candidate permutations into L specificity groups comprises selecting, for each one of the specificity groups, candidate permutations having overall specificity ranks, S_{R}, which differ by an approximately equal amount.

19. A set of textually represented permutations as defined in claim 17, wherein separating the candidate permutations into L specificity groups comprises selecting candidate permutations in proportion to the square roots of the overall specificity rank, S_{R}, of the respective candidate permutations.

20. A set of textually represented permutations as defined in claim 19, further comprising allocating each one of the candidate permutations to a specificity group, S_{G}, in accordance with the equation:
$${S}_{G} = INT ( \sqrt{{S}_{R} - 1} \times \frac{L - 1}{\sqrt{{P}_{T} - 1}} ) + 1.$$
